(19) United States
(12) Patent Application Publication
(10) Pub. No.: US 2025/0247575 A1
(43) Pub. Date: Jul. 31, 2025

(54) SERVER AND METHOD

(71) Applicant: 17LIVE Japan Inc., Tokyo (JP)

(72) Inventor: Ryo MIKAMI, Tokyo (JP)

(21) Appl. No.: 19/041,054

(22) Filed: Jan. 30, 2025

(30) Foreign Application Priority Data
Jan. 31, 2024 (JP) 2024-013637
Apr. 26, 2024 (JP) 2024-073239
May 14, 2024 (JP) 2024-078928

(51) Int. Cl. H04N 21/262; H04N 21/2187

(52) U.S. Cl. CPC H04N 21/26241; H04N 21/2187

(57) ABSTRACT

A server includes a circuitry configured to: start, in a starting unit, a preferential delivery period of a livestream in response to reception of a preferential delivery period start request from a livestreamer performing the livestream during the livestream; manage, in a managing unit, when a next preferential delivery period can be started for the livestream; and perform processing, in a processing unit, to provide information on livestreams that are in the preferential delivery period to a user in priority over information on livestreams outside of the preferential delivery period.

### CROSS-REFERENCE TO RELATED APPLICATIONS

This application is based on and claims the benefit of priority from Japanese Patent Application Serial Nos. 2024-013637 (filed on Jan. 31, 2024), 2024-073239 (filed on Apr. 26, 2024), 2024-078928 (filed on May 14, 2024), the contents of each of which are hereby incorporated by reference in their entirety.

### TECHNICAL FIELD

The present disclosure relates to a server and a method.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video streaming services also became popular as storage costs were reduced. And nowadays or in the Reiwa period (2019 to present), with the sophistication of smartphones and further improvements in network speed as typified by 5G, services that enable real-time communication through video, especially livestreaming services, are gaining recognition. The number of users of livestreaming services is expanding, especially among young people, as such services allow people to share the same good time even when they are in the separate locations from each other.

### SUMMARY

One aspect of the disclosure relates to a server. The server includes a circuitry configured to: start, in a starting unit, a preferential delivery period of a livestream in response to reception of a preferential delivery period start request from a terminal of a livestreamer performing the livestream during the livestream; manage, in a managing unit, when a next preferential delivery period can be started for the livestream; and perform processing, in a processing unit, to provide information on livestreams that are in the preferential delivery period to a user in priority over information on livestreams outside of the preferential delivery period.

Another aspect of the disclosure relates to a terminal of a livestreamer of a livestream that includes: one or more processors; and memory storing one or more computer programs configured to be executed by the one or more processors. The one or more computer programs includes instructions for: receiving an instruction to start a preferential delivery period from the livestreamer during the livestream; transmitting a preferential delivery period start request to a server over a network in response to the reception of the instruction to start the preferential delivery period; and starting to receive an instruction to start the next preferential delivery period once time when the next preferential delivery period can be started comes.

Yet another aspect of the present disclosure relates to a server. The server includes: a receiving unit for receiving a gift use signal from a user terminal of a viewer who is participating a livestream in progress over a network, the gift use signal indicating that a gift is used for a livestreamer of the livestream; a lottery unit selecting, upon reception of the gift use signal, one lottery result from among a plurality of lottery results in accordance with a predetermined lottery algorithm, each lottery result corresponding to a different amount of electronic representation of value; a granting unit granting an amount of electronic representation of value corresponding to the selected lottery result to the livestreamer of the livestream; and a counting unit counting a number of times the gift is used with reference to when a lottery result corresponding to a largest amount of the electronic representation of value is selected from among the plurality of lottery results. The predetermined lottery algorithm is configured such that a predetermined lottery result is selected when the number of times the gift is used reaches a threshold value. It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### BRIEF DESCRIPTION OF THE DRAWINGS

FIG. 1 schematically illustrates provision of a livestream by a livestreaming system in one embodiment.

FIG. 2 schematically illustrates a configuration of a livestreaming system in one embodiment.

FIG. 3 is a block diagram showing functions and configuration of a user terminal in FIG. 2.

FIG. 4 is a block diagram showing functions and configuration of a server in FIG. 2.

FIG. 5 is a data structure diagram showing an example of a stream DB in FIG. 4.

FIG. 6 is a data structure diagram showing an example of a user DB in FIG. 4.

FIG. 7 is a data structure diagram showing an example of a gift DB in FIG. 4.

FIG. 8 is a data structure diagram showing an example of a core time livestream list in FIG. 4.

FIG. 9 is a data structure diagram showing an example of a recommendation list DB in FIG. 4.

FIG. 10 is a flowchart showing a series of steps performed on a user terminal of a livestreamer during a livestream.

FIG. 11 is a representative screen image of a livestreaming room screen appearing on the display of a streamer's user terminal.

FIG. 12 is a representative screen image of a livestreaming room screen appearing on the display of a streamer's user terminal.

FIG. 13 is a flowchart showing a series of steps performed to update the core time livestream list on the server.

FIG. 14 is a flowchart showing a series of steps performed in the livestreaming system when providing a livestream to a user terminal of a viewer.

FIG. 15 is a representative screen image of a livestreaming room screen on a display of a user terminal of a target user.

FIG. 16 is a representative screen image of a livestream selection screen on the display of the user terminal of the target user.

FIG. 17 is a block diagram showing an example of hardware configuration of an information processing device according to the embodiment.

FIG. 18 is a block diagram showing functions and configuration of a server according to a second embodiment.

FIG. 19 is a data structure diagram showing an example of a stream DB in FIG. 18.

FIG. 20 is a data structure diagram showing an example of a user DB in FIG. 18.

FIG. 21 is a data structure diagram showing an example of a gift DB in FIG. 18.

FIG. 22 is a data structure diagram showing an example of a lottery algorithm DB in FIG. 18.

FIG. 23 is a flow chart showing a series of steps of a process performed in the live-streaming system when a viewer uses a random gift during a livestream.

FIG. 24 is a representative screen image of a livestream selection screen on a user terminal display of an active user.

FIG. 25 is a representative screen image of a livestreaming room screen on a display of a viewer's user terminal.

FIG. 26 is a representative screen image of a livestreaming room screen on which a gift region is superimposed on the display of the viewer's user terminal.

FIG. 27 is a representative screen image of a livestreaming room screen on which an effect of a ceiling jackpot is superimposed on the display of the viewer's user terminal.

FIG. 28 is a representative screen image of a livestreaming room screen on which an effect of a jackpot is superimposed on the display of the viewer's user terminal.

FIG. 29 is a representative screen image of the livestreaming room screen having a ceiling jackpot notification display region superimposed thereon, which appears on the display of the viewer's user terminal.

### DESCRIPTION OF THE EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

### First Embodiment

Although some users may access a livestreaming platform by specifying a particular livestream, in most cases, a livestreaming platform provides users with information about ongoing livestreams, such as a list of available livestreams and profiles of livestreamers. Users select a livestream they want to watch from the information provided and watch it. The livestreaming platform can determine a priority level of a livestream to be provided or a livestream recommended to a user according to the degree of matching between the user and a livestreamer or the livestream (see, for example, Japanese Patent Application Publication No. 2023-122470). The user is provided with information on the livestreams that the user is more likely to be interested in, allowing the user to enjoy the livestreams more.

In the livestreaming recommendation mechanism as described in Japanese Patent Application Publication No. 2023-122470, the system decides which livestreams to recommend to a user based on a matching score between the user and the livestreams. Basically, livestreamer's operations and intentions are not directly considered in the process of deciding the livestreams to recommend.

One of the characteristics of livestreaming is that it does not follow a fixed scenario but proceeds freely depending on live interactions between the livestreamer and viewers. Thus, excitement and showmanship during the livestream may come in waves, and it is difficult for the system to accurately predict when such a wave will occur.

The livestreamer can surely tell such as that his/her livestream is about to getting excited exciting, that the livestream is currently getting exciting, that it is currently taking a break, or that a high spot is about to continue during the livestream. However, in conventional livestreaming services, livestreamer's actions are not directly reflected in the selection of livestreams to be provided, so the livestreamer's such perceptions are not utilized.

The first embodiment of the disclosure was made in view of the above and to provide a livestreaming mechanism that can reflect actions of livestreamers. According to the first embodiment, it is possible to provide the livestreaming mechanism that can reflect actions of livestreamers.

In the livestreaming system of the first embodiment, when a livestreamer broadcasting a livestream presses a “core time button”, a core time of that livestream starts. The livestreaming system provides a user with a livestream selected from a list of livestreams that are in the core time. Implemented on a user terminal of the user is UI that allows only livestreams of livestreamers who have pressed the “core time button” to be shown one after another by swiping or sliding up and down. The core time lasts for a relatively short predetermined period of time. The “core time button” is configured so that once it is pressed, the user must wait a predetermined waiting period before being able to press it again. For example, the “core time button” can only be pressed once an hour, and each core time lasts for three minutes.

In the first embodiment, information on livestreams that are in a preferential delivery period is provided to users in priority over information on livestreams outside of the preferential delivery period. This preferential delivery period is hereunder referred to as the core time.

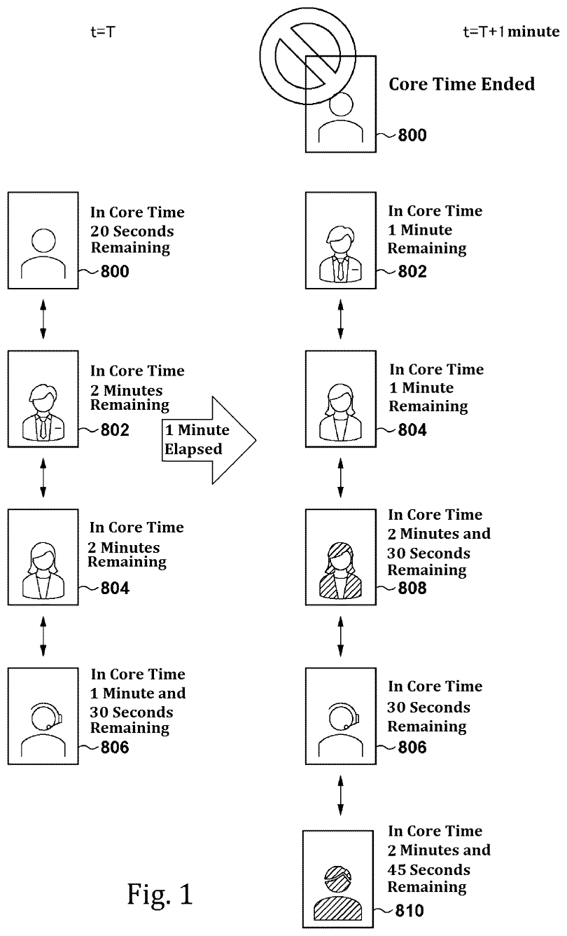

FIG. 1 schematically illustrates provision of a livestream by the livestreaming system of the first embodiment. At some time t=T, four livestreams in progress, which are a first livestream 800, a second livestream 802, a third livestream 804, and a fourth livestream 806, are in the core time. At the time t=T, a user is able to switch the screen to the second livestream 802 by swiping up on the first livestream 800, and can switch back to the first livestream 800 by swiping down on the second livestream 802. The same applies between the second livestream 802 and the third livestream 804, and between the third livestream 804 and the fourth livestream 806. The four livestreams may be ordered depending on respective matching scores with the user. At the time t=T, the remaining core time of the first livestream 800 is 20 seconds, the remaining core time of the second livestream 802 is two minutes, the remaining core time of the third livestream 804 is two minutes, and the remaining core time of the fourth livestream 806 is one minute and 30 seconds. In addition to these four livestreams, there is at least one other livestream in progress that is not in the core time (outside of the core time) in the livestreaming system, but these four livestreams that are in the core time are given priority to be delivered to the user. For example, the system may be configured so that the user must take more effort (e.g., tapping or searching) to view the livestreams that are not in the core time.

At time t=T+1 minute, which is one minute after the time t=T, five livestreams in progress, which are the second livestream 802, the third livestream 804, a fifth livestream 808, the fourth livestream 806, and a sixth livestream 810, are in the core time. At the time t=T+1 minute, the core time of the first livestream 800 has ended, so the first livestream 800 is excluded from the list of livestreams to be provided. At the time t=T+1 minute, the user is able to switch the screen to the third livestream 804 by swiping up on the second livestream 802, and also can switch back to the second livestream 802 by swiping down on the third livestream 804. The same applies between the third livestream 804 and the fifth livestream 808, between the fifth livestream 808 and the fourth livestream 806, and between the fourth livestream 806 and the sixth livestream 810. The five livestreams may be ordered depending on respective matching scores with the user. In FIG. 1, during the elapsed one minute, the fifth livestream 808 and sixth livestream 810 enter a new core time, and according to a result of matching with the user, the fifth livestream 808 is placed above the fourth livestream 806 and the sixth livestream 810 is placed below the fourth livestream 806 in the preferential order.

In this way, in the livestreaming system, livestreams that are being livestreamed and in the core time are preferentially delivered to users over livestreams that are being livestreamed but not in the core time. When the core time of a livestream ends due to the passage of time, the livestream is no longer prioritized. In this way, a livestreamer is able to specify when to enter the core time, so that the livestreamer can enter the core time when he/she wants to promote or market his/her livestream, such as when his/her livestream is about to be exciting, when it is getting exciting, or when a high spot is about to come. Thus, when a livestream is relatively exciting or entertaining, that livestream is preferentially delivered to users, and thus the users can watch more exciting livestream and the livestreamer can increase viewer retention for his/her livestream.

Conventional livestreaming systems select livestreams to be prioritized at any given time, so for example, a livestream may be selected to be preferentially delivered to viewers even when the livestream happens to be quiet and its viewers may lose interest, or the livestream is not selected to be preferentially delivered when the livestream is very exciting and the livestreamer loses the opportunity to acquire viewers. Whereas the livestreaming system of the embodiment allows livestreamers to choose when their livestreams are preferentially delivered to users, the above mismatches that would occur with the conventional art can be reduced or eliminated.

In addition, introduction of the waiting period prevents or eliminates overuse of the core time button. The infrequency of the core time encourages the livestreamers to focus on the right timing for pressing the core time button. In this way, the quality and excitement of the livestreams during the core time can be enhanced.

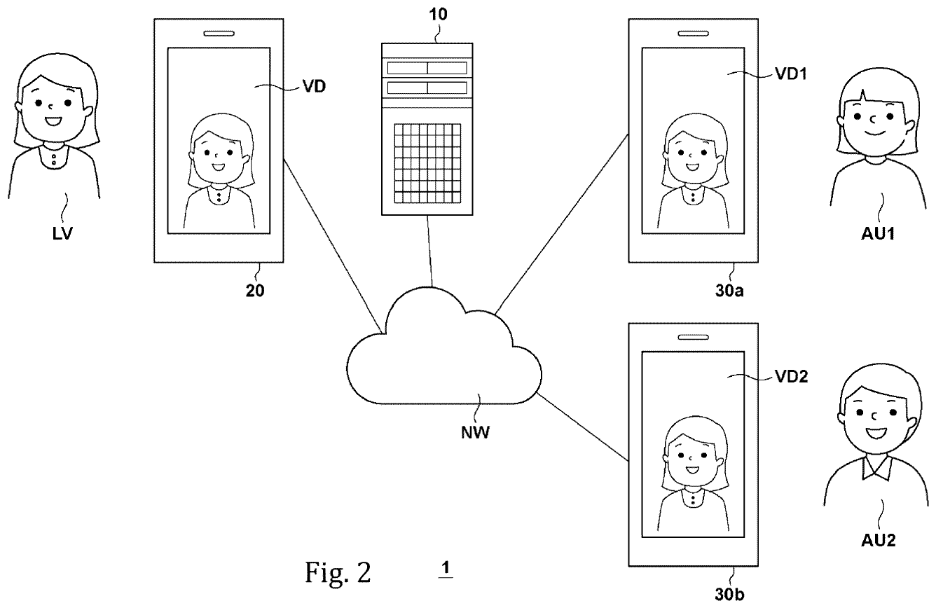

FIG. 2 schematically illustrates the configuration of the livestreaming system 1 according the embodiment of the disclosure. The livestreaming system 1 provides an interactive livestreaming service that allows a livestreamer LV (also referred to as a liver or streamer) and viewers AU (also referred to as audience) (AU1, AU2, . . . ) to communicate in real time. As shown in FIG. 2, the livestreaming system 1 includes a server 10, a user terminal 20 on the livestreamer side, and user terminals 30 (30a, 30b, . . . ) on the viewer side. In addition to the livestreamers who are livestreaming and the viewers who are watching the livestreams, there may be users who have logged in to the livestreaming platform but are neither livestreaming nor watching the livestreams. Such users are herein referred to as active users. The livestreamers, the viewers, and the active users may be collectively referred to as users. The server 10 may be constituted by one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminals 30 are interconnected so as to be able to communicate with each other over the various wired or wireless network NW.

The livestreaming system 1 involves the livestreamer LV, the viewers AU, and an administrator (not shown) who manages the server 10. The livestreamer LV is a person who broadcasts contents in real time by recording the contents with his/her user terminal 20 and uploading them directly to the server 1. Examples of the contents may include the livestreamer's own songs, talks, performances, fortune-telling, gameplays, and any other contents. The administrator provides a platform for livestreaming contents on the server 10, and also mediates or manages real-time interactions between the livestreamer LV and the viewers AU. The viewers AU access the platform through their user terminals 30 to select and view a desired content. During livestreaming of the selected content, the viewer AU performs operations to comment, cheer, or ask fortune-telling via the user terminal 30, the livestreamer LV who is delivering the content responds to such a comment, cheer, or request and such response is transmitted to the viewer AU via video and/or audio, thereby establishing an interactive communication.

As used herein, the term “livestreaming” or “livestream” may mean a mode of data transmission that allows a content recorded at the user terminal 20 of the livestreamer LV to be played and viewed at the user terminals 30 of the viewers AU substantially in real time, or it may mean a live broadcast realized by such a mode of transmission. The livestreaming may be achieved using existing livestreaming technologies such as HTTP Live Streaming, Common Media Application Format, Web Real-Time Communications, Real-Time Messaging Protocol and MPEG DASH. The livestreaming includes a transmission mode in which, while the livestreamer LV is recording contents, the viewers AU can view the contents with a certain delay. The delay is acceptable as long as interaction between the livestreamer LV and the viewers AU can be at least established. Note that the livestreaming is distinguished from so-called on-demand distribution, in which contents are entirely recorded and the entire data is once stored on the server and the server provides users with the data at any subsequent time upon request from the users.

The term “video data” herein refers to data that includes image data (also referred to as moving image data) generated using an image capturing function of the user terminals 20 and 30 and audio data generated using an audio input function of the user terminals 20 and 30. Video data is played back on the user terminals 20 and 30, so that the users can view contents. In this embodiment, it is assumed that between video data generation at the livestreamer's user terminal and video data reproduction at the viewer's user terminal, processing is performed on the video data to change its format, size, or specifications, and examples of such processing include compression, decompression, encoding, decoding, and transcoding. However, such processing does not substantially change the content (e.g., video images and audios) represented by the video data, so that the video data after such processing is herein described as the same as the video data before such processing. In other words, when video data is generated at the livestreamer's user terminal, transmitted via the server 10, and then reproduced at the viewer's user terminal, the video data generated at the livestreamer's user terminal, the video data that passes through the server 10, and the video data received and reproduced at the viewer's user terminal are all the same video data.

In the example in FIG. 2, a livestreamer LV is livestreaming his/her talk. The user terminal 20 of the livestreamer LV generates video data by recording images and sounds of the livestreamer LV who is talking, and the generated video data is transmitted to the server 10 over the network NW. At the same time, the user terminal 20 displays the recorded video image VD of the livestreamer LV on the display of the user terminal 20 to allow the livestreamer LV to check the livestream currently performed.

The respective user terminals 30a and 30b of the viewers AU1 and AU2, who have requested the platform to enable them to view the livestream of the livestreamer LV, receive video data related to the livestream over the network NW and reproduce the received video data, to display video images VD1 and VD2 on the displays and output audio through the speakers. The video images VD1 and VD2 displayed at the user terminals 30a and 30b, respectively, are substantially the same as the video image VD captured by the user terminal 20 of the livestreamer LV, and the audio outputted at the user terminals 30a and 30b is substantially the same as the audio recorded by the user terminal 20 of the livestreamer LV.

Recording of the images and sounds at the user terminal 20 of the livestreamer LV and reproduction of the video data at the user terminals 30a and 30b of the viewers AU1 and AU2 are performed substantially simultaneously. The viewer AU1 may type a comment about the talk of the livestreamer LV on the user terminal 30a, and the server 10 may display the comment on the user terminal 20 of the livestreamer LV in real time and also display the comment on the user terminals 30a and 30b of the viewers AU1 and AU2, respectively. The livestreamer LV may read the comment and develop his/her talk to cover and respond to the comment, and the video and sound of the talk are output on the user terminals 30a and 30b of the viewers AU1 and AU2, respectively. This interactive action is recognized as establishment of a conversation between the livestreamer LV and the viewer AU1. In this way, the livestreaming system 1 realizes a livestream that enables the interactive communication, not one-way communication.

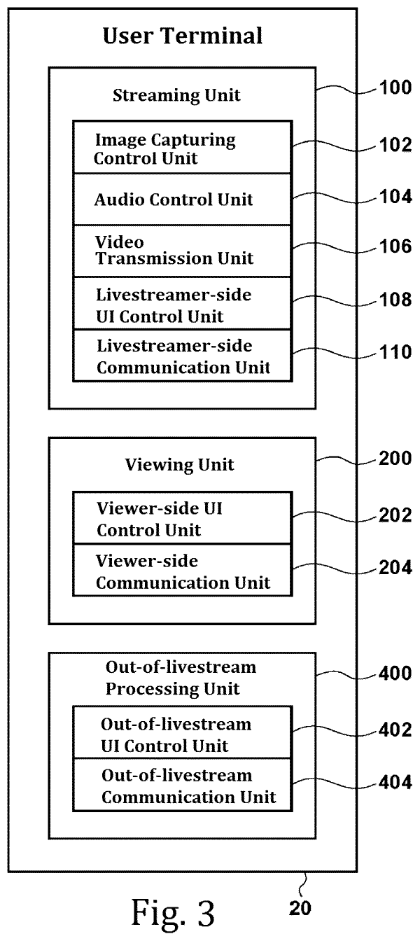

FIG. 3 is a block diagram showing functions and configuration of the user terminal 20 of FIG. 2. The user terminals 30 have the same functions and configuration as the user terminal 20. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The users download and install a livestreaming application program (hereinafter referred to as a livestreaming application) onto the user terminals 20 and 30 from a download site over the network NW. Alternatively, the livestreaming application may be pre-installed on the user terminals 20 and 30. When the livestreaming application is executed on the user terminals 20 and 30, the user terminals 20 and 30 communicate with the server 10 over the network NW to implement various functions. Hereinafter, the functions implemented by (processors such as CPUs of) the user terminals 20 and 30 running the livestreaming application will be described as functions of the user terminals 20 and 30. These functions are realized in practice by the livestreaming application on the user terminals 20 and 30. In any other embodiments, these functions may be realized by a computer program written in a programming language such as HTML (HyperText Markup Language), which is transmitted from the server 10 to web browsers of the user terminals 20 and 30 over the network NW and executed by the web browsers.

The user terminal 20 includes a streaming unit 100 for generating a video data in which the user's image and sound are recorded and providing the video data to the server 10, a viewing unit 200 for acquiring and reproducing the video data from the server 10, and an out-of-livestream processing unit 400 for processing requests made by active users. The user activates the streaming unit 100 to livestream, the viewing unit 200 to view a livestream, and the out-of-livestream processing unit 400 to look for a livestream, view a livestreamer's profile, or watch an archive. The user terminal having the livestreaming unit 100 activated is the livestreamer's terminal, i.e., the user terminal that generates video data, the user terminal having the viewing unit 200 activated is the viewer's terminal, i.e., the user terminal that reproduces video data, and the user terminal having the out-of-livestream processing unit 400 activated is the active user's terminal.

The livestreaming unit 100 includes an image capturing control unit 102, an audio control unit 104, a video transmission unit 106, a livestreamer-side UI control unit 108, and a livestreamer-side communication unit 110. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time.

The livestreamer-side UI control unit 108 controls a UI for the livestreamer. The livestreamer-side UI control unit 108 is connected to a display (not shown in FIG. 2), and displays a video image on the display by reproducing the video data that is to be transmitted by the video transmission unit 106. The livestreamer-side UI control unit 108 is also connected to input means (not shown in FIG. 2) such as touch panels, keyboards, and displays, and obtains the livestreamer's input via the input means. The livestreamer-side UI control unit 108 superimposes a predetermined frame image on the video image. The frame image includes various user interface objects (hereinafter simply referred to as “objects”) for receiving inputs from the livestreamer, comments entered by the viewers, and information obtained from the server 10. The livestreamer-side UI control unit 108 receives, for example, the livestreamer's inputs made by the livestreamer tapping the objects. The objects include the core time button.

The livestreamer-side communication unit 110 controls communication with the server 10 during a livestream. The livestreamer-side communication unit 110 transmits the content of the livestreamer's input that has been obtained by the livestreamer-side UI control unit 108 to the server 10 over the network NW. The livestreamer-side communication unit 110 receives various information associated with the livestream from the server 10 over the network NW.

The viewing unit 200 includes a viewer-side UI control unit 202 and a viewer-side communication unit 204. The viewer-side communication unit 204 controls communication with the server 10 during a livestream. The viewer-side communication unit 204 receives, from the server 10 over the network NW, video data related to the livestream in which the livestreamer and the viewer participate.

The viewer-side UI control unit 202 controls the UI for the viewer. The viewer-side UI control unit 202 is connected to a display and a speaker (not shown in FIG. 2), and reproduces the received video data so that the video images are displayed on the display and the sounds are output through the speaker. The state where the images and sounds are respectively output through the display and speaker can be referred to as “the video data is reproduced”. The viewer-side UI control unit 202 is also connected to input means (not shown in FIG. 2) such as touch panels, keyboards, and displays, and obtains the viewer's input via the input means. The viewer-side UI control unit 202 superimposes a predetermined frame image on an image generated from the video data obtained from the server 10. The frame image includes various objects for receiving inputs from the viewer, comments entered by the viewer, and information obtained from the server 10. The viewer-side communication unit 204 transmits the content of the viewer's input that has been obtained by the viewer-side UI control unit 202 to the server 10 over the network NW.

The out-of-livestream processing unit 400 includes an out-of-livestream UI control unit 402 and an out-of-livestream communication unit 404. The out-of-livestream UI control unit 402 controls a UI for the active user. For example, the out-of-livestream UI control unit 402 generates a livestream selection screen and shows the screen on the display. The livestream selection screen presents a list of livestreams to which the active user is currently invited to participate to allow the active user to select a live stream. The out-of-livestream UI control unit 402 generates a profile screen for any user and shows the screen on the display. The out-of-livestream UI control unit 402 plays back an archive generated by recording past livestreams.

The out-of-livestream communication unit 404 controls communication with the server 10 that takes place outside a livestream. The out-of-livestream communication unit 404 receives, from the server 10 over the network NW, information necessary to generate the livestream selection screen, information necessary to generate the profile screen, and archived data. The out-of-livestream communication unit 404 transmits the content of the active user's input to the server 10 over the network NW.

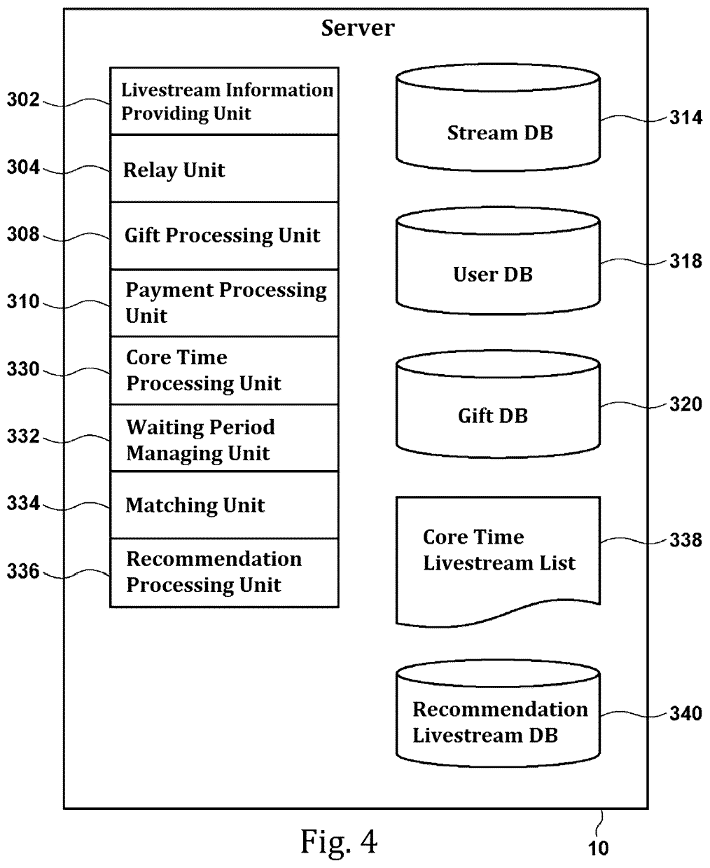

FIG. 4 is a block diagram showing functions and configuration of the server 10 of FIG. 2. The server 10 includes a livestream information providing unit 302, a relay unit 304, a gift processing unit 308, a payment processing unit 310, a core time processing unit 330, a waiting period managing unit 332, a matching unit 334, a recommendation processing unit 336, a stream DB 314, a user DB 318, a gift DB 320, a core time livestream list 338, and a recommendation livestream DB 340.

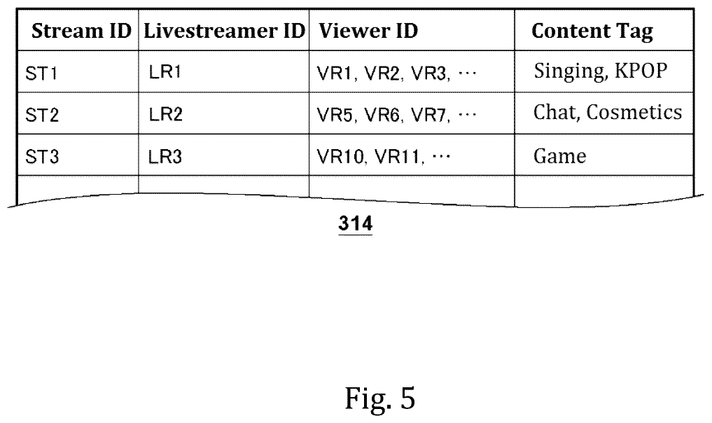

FIG. 5 is a data structure diagram showing an example of the stream DB 314 of FIG. 4. The stream DB 314 holds information regarding livestreams currently taking place. The stream DB 314 stores a stream ID for identifying a livestream on a live-streaming platform provided by the livestreaming system 1, a livestreamer ID, which is a user ID for identifying the livestreamer who provides the livestream, a viewer ID, which is a user ID for identifying a viewer of the livestream, and a tag indicating the content of the livestream, in association with each other.

In the livestreaming platform provided by the livestreaming system 1 of the embodiment, when a user delivers a livestream, the user is referred to as a livestreamer, and when the same user views a livestream delivered by another user, the user is referred to as a viewer. Therefore, the distinction between a livestreamer and a viewer is not fixed, and a user ID registered as a livestreamer ID at one time may be registered as a viewer ID at another time.

The content tag of a livestream may be designated by the livestreamer when starting the livestream or obtained from real-time analysis of the livestream by a machine learning model.

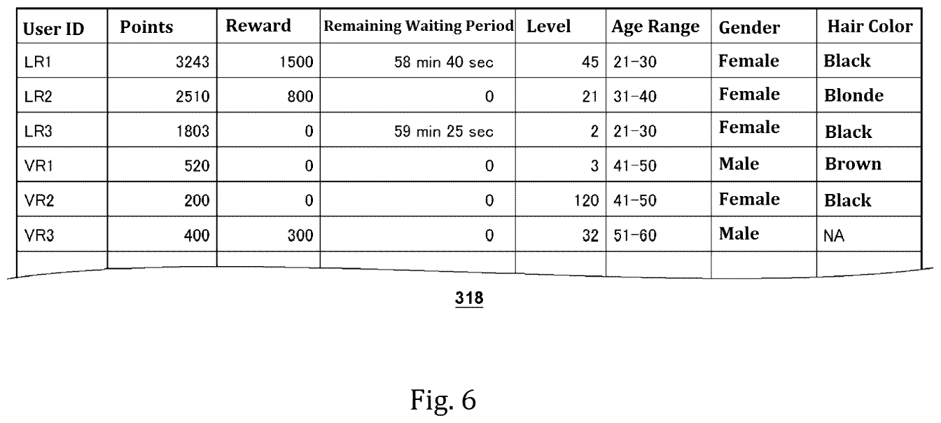

FIG. 6 is a data structure diagram showing an example of the user DB 318 of FIG. 4. The user DB 318 holds information regarding users. The user DB 318 holds a user ID identifying the user, points the user has, a reward given to the user, the remaining time of the waiting period for the user, the level of the user, and attributes of the user, in association with each other. The attributes of the user include the age range where the user's age is included, the gender of the user, and the hair color of the user.

The points are an electronic representation of value circulated in the livestreaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

The level is an indicator of the user's past performance as a livestreamer on the livestreaming platform. In other embodiments, the level may be an indicator of the user's past performance as a viewer on the livestreaming platform or it may be an indicator of the user's past performance as a livestreamer and as a viewer. The level may increase or decrease depending on the number of times the user has delivered a livestream, the streaming time of the livestreams, the total viewed time of the livestreams, the total viewing time as a viewer of livestreams, the number and/or amount of gifts the user has given, the number and/or amount of gifts the user has received, the number of comments, etc. Alternatively, the level may be evaluated and determined by the administrator based on reviews about the livestreamer, user satisfaction, and comments posted during the livestream. Alternatively, the level may be automatically determined based on predetermined rules or by a machine learning model.

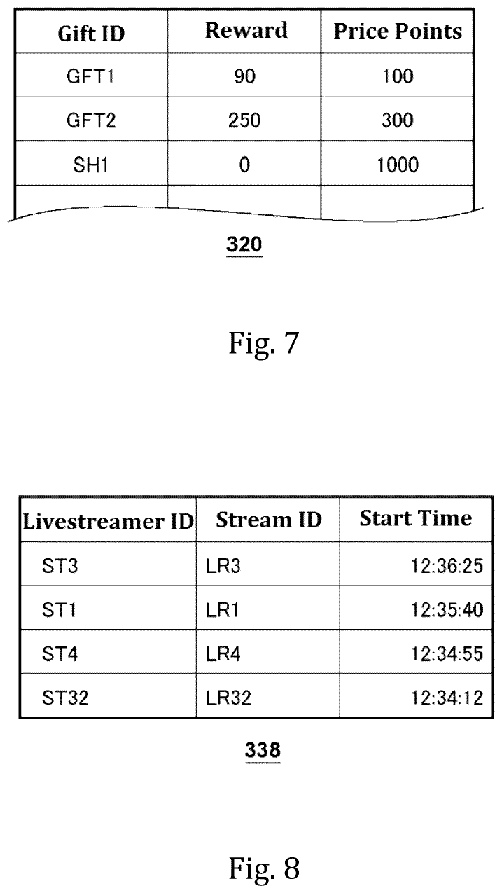

FIG. 7 is a data structure diagram showing an example of the gift DB 320 of FIG. 4. The gift DB 320 holds information regarding gifts available for the viewers in relation to the livestreaming. A gift is electronic data with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be used by the viewer at any time after purchased.
When a viewer gives a gift to a livestreamer, the livestreamer is awarded a corresponding reward.
When a gift is used, the use may trigger an effect associated with the gift. For example, an effect corresponding to the gift will appear on the livestreaming room screen.

The gift DB 320 stores: a gift ID for identifying a gift; a reward to be awarded, which is a reward awarded to a livestreamer when the gift is given to the livestreamer; and price points, which is the amount of points to be paid for use of the gift, in association with each other. A viewer is able to give a desired gift to a livestreamer by paying the price points of the desired gift while viewing the livestream. The payment of the price points may be made by appropriate electronic payment means. For example, the payment may be made by the viewer paying the price points to the administrator. Alternatively, bank transfers or credit card payments may be available. The administrator can freely determine the relationship between the reward to be awarded and the price points. For example, the administrator may determine that the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points.

In the embodiment, a waiting period shortening gift is provided. For example, a gift “SH1” in FIG. 7 is set as the waiting period shortening gift. When the waiting period shortening gift is used by a viewer during a livestream, the waiting period for that livestream is shortened. Shortening the waiting period may be achieved by decreasing the remaining time of the current waiting period by a predetermined amount, or by speeding up the countdown of the waiting period. For example, if the gift “SH1” in FIG. 7 is used during the livestream, the remaining time of the waiting period for the livestream at that time is reduced by 30 seconds. In other words, if the remaining time was 2 minutes and 15 seconds, the use of gift “SH1” would reduce the remaining time to 1 minute and 45 seconds.

FIG. 8 is a data structure diagram showing an example of the core time livestream list 338 of FIG. 4. The core time livestream list 338 is a list of livestreams that are in the core time (within the preferential delivery period). The core time may be a period of time during which the livestream is preferentially delivered to users. The core time livestream list 338 may include information only on livestreams that are in the core time. The length of the core time may be fixed or variable. The core time livestream list 338 holds the correspondence between the livestreamer ID of the livestreamer of the livestream in the core time, the stream ID of the livestream, and the time when the core time of the livestream started.

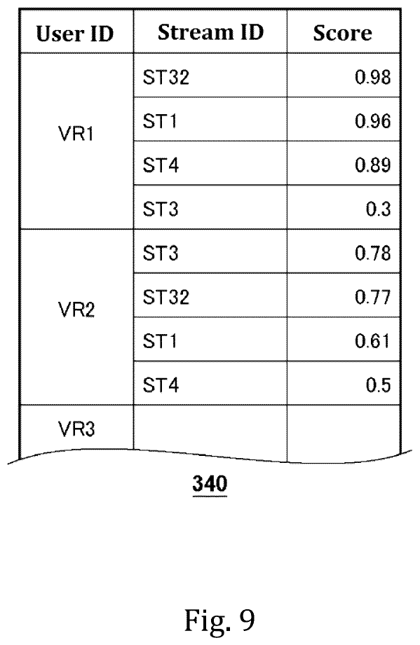

FIG. 9 is a data structure diagram showing an example of a recommendation list DB 340 in FIG. 4. The recommendation list DB 340 holds, for each user, a recommendation list, which is a list of recommended livestreams that are in the core time (hereinafter referred to as “recommended livestreams”) for the user.

The recommendation list DB 340 stores the user ID of a user and the recommendation list for the user in association with each other. The recommendation list for a user is associated with the stream IDs of the livestreams to be recommended for the user and matching score values between the livestreams to be recommended and the user. In the recommendation list, the livestreams to be recommended are listed in descending order of the matching scores.

Referring again to FIG. 4, the core time processing unit 330 controls the core time of a livestream currently in progress. When the core time processing unit 330 receives a core time start request over the network NW from the user terminal 20 of a livestreamer who is performing a livestream, the core time processing unit 330 starts the core time of that livestream.

The core time processing unit 330 manages when the next core time for the livestream can be started. The core time processing unit 330 enables the start of the next core time when the waiting period that is longer than the current core time has elapsed since the core time started for the livestream. The length of the core time may be set to one minute, three minutes, five minutes, ten minutes and the like. The length of the waiting period may be set to 30 minutes, one hour, three hours and the like longer than the length of the core time.

Although the length of the core time is fixed as a system parameter in this embodiment, the length of the core time may be adjusted dynamically in other embodiments. For example, the core time processing unit 330 may adjust the length of the core time depending on changes in parameters during a livestream. The core time processing unit 330 may measure the degree of excitement of the livestream in the core time. When the degree satisfies a predetermined extension condition, The core time processing unit 330 may perform processing to extend the core time of the livestream by a predetermined amount may be performed. The degree of excitement may be estimated by a mathematical formula using the number of comments, the number and amount of gifts, the number of yells, etc. as inputs. The extension condition may be satisfied when the degree of excitement exceed a threshold or when the condition continues for a predetermined period of time. Alternatively, when the core time extension gift is used by a viewer during the livestream, the core time processing unit 330 may perform processing to extend the core time of the livestream. Alternatively, when a payment is received from the livestreamer of the livestream in the core time, the core time processing unit 330 may perform processing to extend the core time of the livestream. When the length of the core time is adjusted dynamically and/or depending on users, the user DB 318 may maintain the length of the core time for each user.

The core time processing unit 330 manages or updates the core time livestream list 338. The core time processing unit 330 registers livestreams whose core times have newly started in the core time livestream list 338 and removes livestreams whose previously started core times have expired from the core time livestream list 338. The core time processing unit 330 updates the core time livestream list 338 each time it receives the core time start request. The core time processing unit 330 updates the core time livestream list 338 when a predetermined master update period elapses without receiving the core time start request. The length of the master update period may be set depending on the length of the core time, or it may be set to be shorter than the length of the core time. For example, the length of the master update period may be set to one-tenth or one-fifth of the core time length. Alternatively, the length of the master update period may be set to a fixed value that is sufficiently shorter than the length of the core time. By setting the length of the master update period to be shorter than the length of the core time, the number of livestreams that remain on the core time livestream list 338 even though their core time have expired can be reduced.

The waiting period managing unit 332 shortens the waiting period when there is a payment by the livestreamer performing the livestream or by a viewer watching the livestream. The waiting period managing unit 332 adjusts the length of the waiting period depending on a change(s) in parameter(s) during the livestream. The waiting period managing unit 332 may measure the degree of excitement of the livestream outside the core time. When the degree of excitement satisfies a predetermined shortening condition, the waiting period managing unit 332 may perform processing to shorten the waiting period of the relevant livestream by a predetermined amount. The shortening condition may be satisfied when the degree of excitement exceeds a threshold value or when the condition continues for a predetermined period of time. Conversely, the waiting period managing unit 332 may perform processing to extend the waiting period of the livestream by a predetermined amount when the degree of excitement of the livestream outside the core time satisfies a predetermined waiting extension condition. The waiting extension condition may be satisfied when the degree of excitement falls below a threshold value, or when the condition continues for a predetermined period of time, or when the livestream is determined to be in the idle state. Alternatively, when the waiting period shortening gift is used by a viewer during the livestream, the waiting period managing unit 332 may perform processing to shorten the waiting period for that livestream. Alternatively, when a payment is received from a livestreamer of a livestream that is not in the core time, the waiting period managing unit 332 may perform processing to shorten the waiting period of that livestream.

The waiting period managing unit 332 adjusts the waiting period by increasing or decreasing the remaining time of the waiting period registered in the user DB 318 for each user. For example, if the waiting period of a user “LR1” should be reduced by 30 minutes, the waiting period managing unit 332 updates the user DB 318 so that 30 minutes is reduced from the current value of the remaining time of the waiting period of the user “LR1”. In the example of FIG. 6, the waiting period managing unit 332 changes the remaining time of the waiting period for the user “LR1” from “58 minutes and 40 seconds” to “28 minutes and 40 seconds”.

The matching unit 334 calculates the matching score between a user who is logged in the livestreaming platform and each livestream that is in the core time. The matching unit 334 obtains attributes of the livestream in the core time. More specifically, the matching unit 334 refers to the stream DB 314 to identify the livestreamer ID and the content tag of the livestream in the core time. The matching unit 334 refers to the user DB 318 to obtain the attributes and the level of the livestreamer corresponding to the identified livestreamer ID. The attributes of the livestream in the core time include the attributes and level of the livestreamer of the livestream and the content tag. The matching unit 334 refers to the user DB 318 to specify the attributes of the user logged into the livestreaming platform. The matching unit 334 calculates the matching score between the user and the livestream from the attributes of the livestream in the core time, the attributes and viewing history of the specified user. The viewing history is obtained from the viewing history DB, which is not shown in the drawing. The calculation of the matching score between the livestream and the user may be realized using known matching techniques, such as those described in Japanese Translation of PCT International Patent Application No. 2020-521207 and Japanese Patent Application Publication No. 2019-164617.

The recommendation processing unit 336 manages and updates the recommendation list DB 340. When a user newly logs into the livestreaming platform, the recommendation processing unit 336 calculates the matching score between this user and each livestream in the core time. The recommendation processing unit 336 generates a recommendation list for the user in descending order of the calculated matching score and registers the list in the recommendation list DB 340. Specifically, the recommendation processing unit 336 generates the recommendation list for the user by rearranging the stream IDs of the livestreams in the core time in such a way that the higher the matching score, the higher that livestream is placed in the ranking. The recommendation processing unit 336 registers the generated recommendation list in the recommendation list DB 340 in association with the user ID of the user.

The recommendation processing unit 336 updates the recommendation list for the user each time a recommendation update period for the user elapses. The length of the recommendation update period may be set depending on the length shorter than the length of the core time. For example, the length of the recommendation update period may be set to one-fifth or one-half of the core time length. Alternatively, the length of the recommendation update period may be set to a fixed value that is sufficiently shorter than the length of the core time. By setting the length of the recommendation update period shorter than the length of the core time, the result of updating the core time livestream list 338 can be reflected in the recommended livestreams in more real-time. For example, the livestreamers will be able to feel the effect of the increased exposure opportunities of entering the core time more quickly.

Upon reception of a notification from the user terminal 20 of a livestreamer that the livestreamer starts a livestream over the network NW, the livestream information providing unit 302 enters in the stream DB 314 the stream ID identifying this livestream and the livestreamer ID of the livestreamer who delivers the livestream.

The livestream information providing unit 302 performs processing to provide the information on livestreams that are in the core time to users preferentially over the information on livestreams that are not in the core time. The livestream information providing unit 302 performs processing to provide users with information of only the livestreams that are in the core time. More specifically, the livestream information providing unit 302 selects livestreams to be delivered to each user from among the livestreams to be recommended registered in the recommendation list for the user.

In the examples of FIGS. 5 and 8, a livestream “ST1” and livestream “ST3” are examples of the livestreams that are in the core time, and a livestream “ST2” is an example of the livestream that is outside of the core time. The livestreams “ST1” and “ST3” are preferentially delivered to users over the livestream “ST2”. As shown in FIG. 1, the livestreaming system is configured such that a livestream selected from the list of recommended livestreams (consisting of livestreams in the core time) is delivered to a user by default in this embodiment. The livestreaming system is also configured such that livestreams that are not in the core time (outside of the core time) cannot be viewed by the user without more effort, such as entering another mode, entering another tab, or searching.

When a user newly logs in to the livestreaming platform, the livestream information providing unit 302 transmits, to the user terminal of that user, information on the livestream that is at the top of the list of recommended livestreams for the user generated by the recommendation processing unit 336. The livestream information providing unit 302 starts delivering the video data of the livestream at the top of the list to the user terminal of the user. The livestream information providing unit 302 updates the stream DB 314 so that the viewer IDs associated with the stream ID of the livestream that has started to be delivered to the user includes the user ID of the user. Thus, the user becomes a viewer of the livestream.

The relay unit 304 relays the video data from the user terminal 20 of the livestreamer of the livestream started by the livestream information providing unit 302 to the user terminal 30 of the viewer. The relay unit 304 receives from the viewer-side communication unit 204 a signal that represents user input by a viewer during the livestream, or during reproduction of the video data. The signal that represents user input includes a swipe signal indicating a swipe or slide input with either up, down, left or right orientation, and an object specifying signal for specifying an object displayed on the display of the user terminal 30. The object specifying signal includes the viewer ID of the viewer, the livestreamer ID of the livestreamer delivering the livestream that the viewer watches, and an object ID that identifies the object. When the object is a gift icon, the object ID is a gift ID. The object specifying signal in that case is a gift use signal indicating that the viewer uses a gift for the livestreamer. Similarly, the relay unit 304 receives from the streamer-side communication unit 110 of the streaming unit 100 in the user terminal 20 a signal that represents user input by the livestreamer during reproduction of the video data, such as the object specifying signal.

When the relay unit 304 received a livestream change request from the user terminal 20 of the viewer of the livestream over the network NW, it selects a new livestream different from the current livestream from the list of recommended livestreams for that viewer. The livestream change request may be a swipe signal indicating swipe up or swipe down. The relay unit 304 starts relaying the transmission of video data pertaining to the selected livestream from the user terminal of the livestreamer of the selected livestream to the user terminal of the viewer from whom the livestream change request was made.

The gift processing unit 308 updates the user DB 318 so as to increase the reward for the livestreamer according to the reward to be awarded of the gift identified by the gift ID included in the gift use signal. Specifically, the gift processing unit 308 refers to the gift DB 320 to specify a reward to be awarded for the gift ID included in the received gift use signal. The gift processing unit 308 then updates the user DB 318 to add the specified reward to be awarded to the reward for the livestreamer ID included in the gift use signal.

The payment processing unit 310 processes payment of a price of the gift by the viewer in response to reception of the gift use signal. Specifically, the payment processing unit 310 refers to the gift DB 320 to specify the price points of the gift identified by the gift ID included in the gift use signal. The payment processing unit 310 then updates the user DB 318 to subtract the specified price points from the points of the viewer identified by the viewer ID included in the gift use signal.

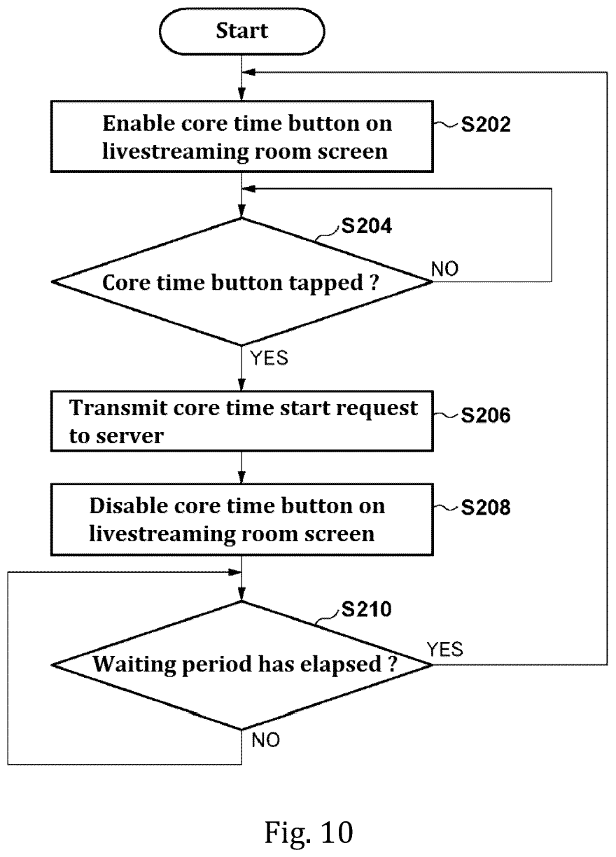

The operation of the livestreaming system 1 with the above configuration will be now described. FIG. 10 is a flowchart showing a series of steps performed on the user terminal 20 of the livestreamer performing the livestream. The livestreamer-side UI control unit 108 of the user terminal 20 displays the live streaming room screen on the display during the livestream, including video image of the livestreamer generated by the user terminal 20. The livestreamer is able to check comments, check the visibility of his/her livestream, indicate the end of livestream, and indicate the start of the core time and the like on the livestreaming room screen. The livestreamer-side UI control unit 108 enables the core time button on the livestreaming room screen shown on the display (S202). The core time button is an object for accepting a core time start instruction from the livestreamer during the livestream. Enabling such an object and disabling it as described below includes activation and deactivation of the object. For example, enabling the core time button may be to start displaying the core time button, to start accepting a tap on or selection of the core time button, or to cause the core time button to be pressable or selectable. Disabling the core time button may be to stop displaying the core time button, to stop accepting taps on or selection of the core time button, or to cause the core time button to be unpressable or unselectable. The core time button may be displayed differently when the core time button is enabled and when the core time button is disabled. In this case, the enabled core time button may be displayed with more emphasis than the disabled core time button. The emphasis and de-emphasis of the buttons may be expressed using color, density, and size.

The livestreamer-side UI control unit 108 waits for a tap on the core time button (S204). The livestreamer-side UI control unit 108 determines whether a tap on the core time button is detected, and if not (N in S204), the processing in S204 is repeated. When the livestreamer-side UI control unit 108 detects the tap on the core time button (Y in S204), the livestreamer-side communication unit 110 generates the core time start request including the stream ID of the livestream associated with the livestreaming room screen on which the tapped core time button is displayed, and transmits it to the server 10 over the network NW (S206).

Once the tap on the core time button is detected, the livestreamer-side UI control unit 108 disables the core time button on the livestreaming room screen on the display (S208). Once the time when the next core time can be started comes, the user terminal 20 starts to accept an instruction to start the next core time. The livestreamer-side UI control unit 108 determines whether the waiting period has elapsed since the core time button was disabled in step S208 (S210). This determination may be achieved, for example, by the livestreamer-side UI control unit 108 counting with a timer or other timing means, or by the livestreamer-side communication unit 110 contacting the server 10. In the former case, when there is a change or increase or decrease in the remaining time of the waiting period other than the normal countdown (for example, when there is a use of a period shortening gift), the waiting period management unit 332 of the server 10 notifies the user terminal 20 over the network NW of the remaining time after the change or increase or decrease, and the livestreamer-side UI control unit 108 of the user terminal 20 updates the waiting period count with the notified remaining time. In the latter case, the livestreamer-side communication unit 110 periodically inquires over the network NW to the server 10 whether the waiting period has expired, and the waiting period managing unit 332 determines whether the waiting period has expired by referring to the user DB 318. The waiting period managing unit 332 returns the result of the decision to the livestreamer-side communication unit 110. In this way, the length of the waiting period determines the timing when the next core time can start after the core time has started.

When the waiting period has elapsed (Y in S210), the livestreamer-side UI control unit 108 goes back to step S202 and re-enables the core time button that was disabled. This initiates reception of the instruction to start the next core time.

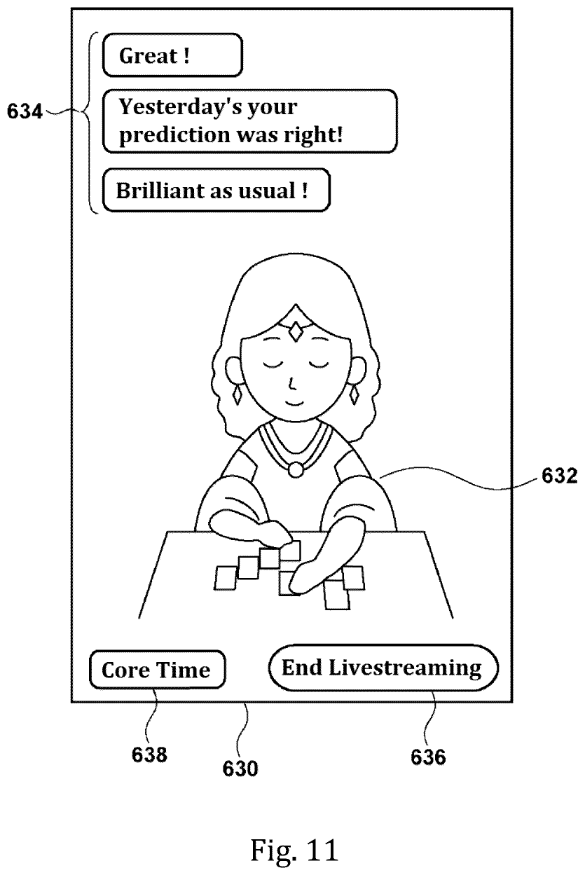

FIG. 11 is a representative screen image of the livestreaming room screen 630 shown on the display of the livestreamer's user terminal 20. The livestreaming room screen 630 of FIG. 11 corresponds to the state where a tap on the core time button is waited in step S204 of FIG. 10. The livestreaming room screen 630 displays a video image generated by the user terminal 20 of the livestreamer in real time. The livestreaming room screen 630 includes a video image 632 of the livestreamer obtained by reproducing the video data transmitted by the video transmission unit 106, a comment display region 634, a livestreaming end button 636, and a core time button 638. The viewer-side UI control unit 108 superimposes various objects such as the livestreaming end button 636, the comment input area 636, the comment display region 634, and the core time button 638 on the video image 632 obtained by reproducing the video data, to generate the livestreaming room screen 630.

The comment display region 634 may include a comment(s) entered by the viewer and a notification(s) from the system. The notification(s) from the system may include information indicating who gave which gift to the livestreamer, information indicating that the core time of the livestreamer's livestream has started, and information indicating that the core time of the livestreamer's livestream has ended. The livestreamer-side UI control unit 108 generates the comment display region 634 including comments of other viewers received from the server 10 and notifications from the system, and the livestreamer-side UI control unit 108 includes the generated comment display region 634 in the livestreaming room screen 630.

The livestreaming end button 636 is an object for accepting an instruction from the livestreamer to terminate the delivery of the livestream.

When a tap on the core time button 638 is detected, the livestreamer-side communication unit 110 of the user terminal 20 generates the core time start request and transmits the request to the server 10 over the network NW. The livestreamer-side UI control unit 108 of the user terminal 20 disables the core time button 638 when the core time start request has sent.

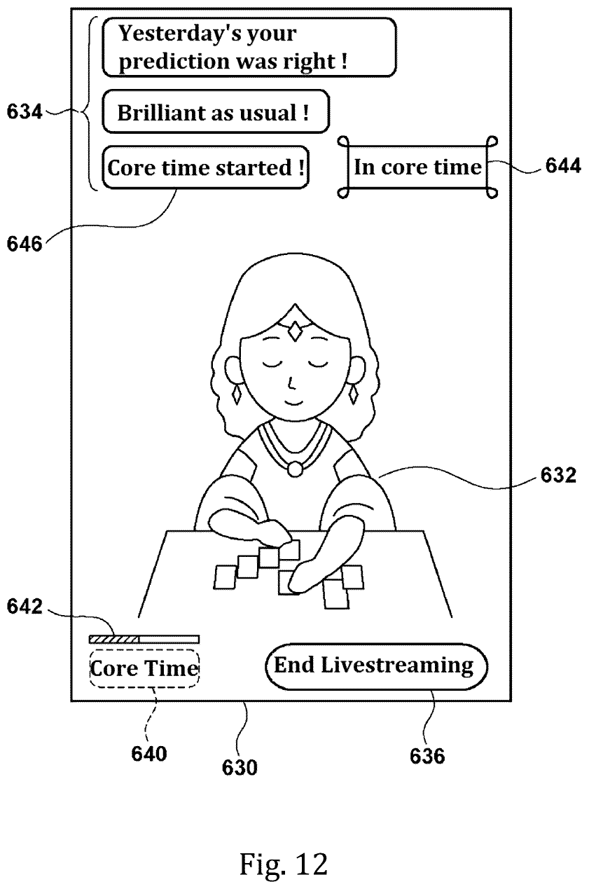

FIG. 12 is a representative screen image of the livestreaming room screen 630 shown on the display of the livestreamer's user terminal 20. The live streaming room screen 630 of FIG. 12 illustrates the state immediately after the core time button is disabled in step S208 of FIG. 10. Once the core time button 638 is tapped on the livestreaming room screen 630 of FIG. 11, the display transitions to the livestreaming room screen 630 of FIG. 12. In FIG. 12, the core time button 640 is grayed out or transparent. The livestreamer-side UI control unit 108 is configured not to accept taps on the core time button 640 in this state. Even if the core time button 640 in this state is tapped, the livestreamer-side UI control unit 108 ignores it. The livestreaming room screen 630 includes an indicator 642 associated with the core time button 640. The indicator 642 indicates the remaining time of the waiting period for the livestream on the livestreaming room screen 630. The livestreamer-side UI control unit 108 updates the indicator 642 according to the count of the waiting period or according to the remaining time obtained from the server 10. The live streaming room screen 630 includes an in-core-time object 644 when the livestream is in the core time. The livestreamer is able to know that he/she is in the core time by the presence of the in-core-time object 644. Once the livestream is registered in the core time livestream list 338 at the server 10 in response to the core time start request sent by tapping the core time button 638 in FIG. 11, the server 10 generates a start message 646 that notifies the start of the core time and transmits it to the user terminal 20 of the livestreamer of the livestream and the viewer's user terminal 30. The livestreamer-side UI control unit 108 of the user terminal 20 includes the received start message 646 in the comment display region 634.

When time passes from the state of the livestreaming room screen 630 of FIG. 12 and the core time expires, the livestreamer-side communication unit 110 receives an end message from the server 10 notifying the end of the core time, and the livestreamer-side UI control unit 108 includes the end message in the comment display region 634. The livestreamer-side UI control unit 108 stops displaying the in-core-time object 644. Thereafter, when the waiting period elapses, the core time button is activated and the display transitions to one identical or similar to the livestreaming room screen 630 shown in FIG. 11.

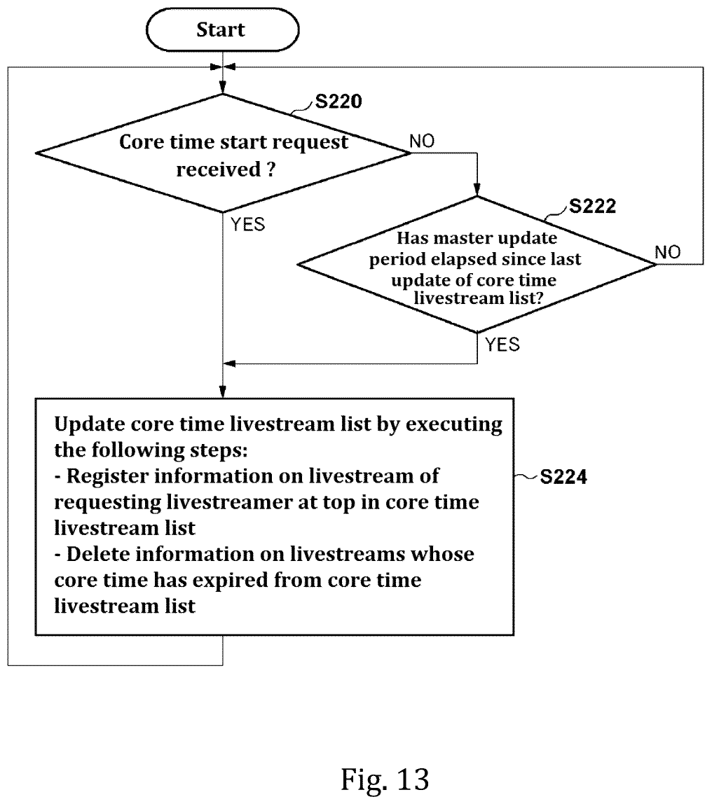

FIG. 13 is a flowchart showing a series of steps performed to update the core time livestream list 338 on the server 10. The core time processing unit 330 waits for the core time start request from the user terminal 20 of the livestreamer who is currently delivering the livestream (S220). When the core time processing unit 330 does not receive the core time start request (N in S220), it determines whether the master update period has elapsed since the last update of the core time livestream list 338 (S222). When the master update period has elapsed (Y in S222), the core time processing unit 330 proceeds to step S224 of updating the core time livestream list, which is described below. When the master update period has not elapsed (N in S222), return to step S220. Thus, the update interval of the core time livestream list 338 is the same as or shorter than the master update period.

When the core time start request is received (Y in S220), the core time processing unit 330 updates the core time livestream list 338 by executing the following steps. After updating, return to step S220. The core time processing unit 330 registers the information on the livestream of the requester (or sender) of the core time start request received in step S220 at the top in the core time livestream list 338. The core time processing unit 330 registers at the top in the core time livestream list 338 the stream ID included in the core time start request, the livestream ID of the livestreamer of the livestream identified by the stream ID, and the time when the core time start request is received, in association with each other. The time when the core time start request is received is registered as the core time start time. Note that when step S224 comes from N in step S222, this registration process is not performed. The core time processing unit 330 deletes the information of the livestreams whose core time have expired from the core time livestream list 338. The core time processing unit 330 calculates a difference between the current time and the start time of the core time of each livestream registered in the core time livestream list 338. The core time processing unit 330 deletes from the core time livestream list 338 the livestreams for which the calculated difference exceeds the core time length.

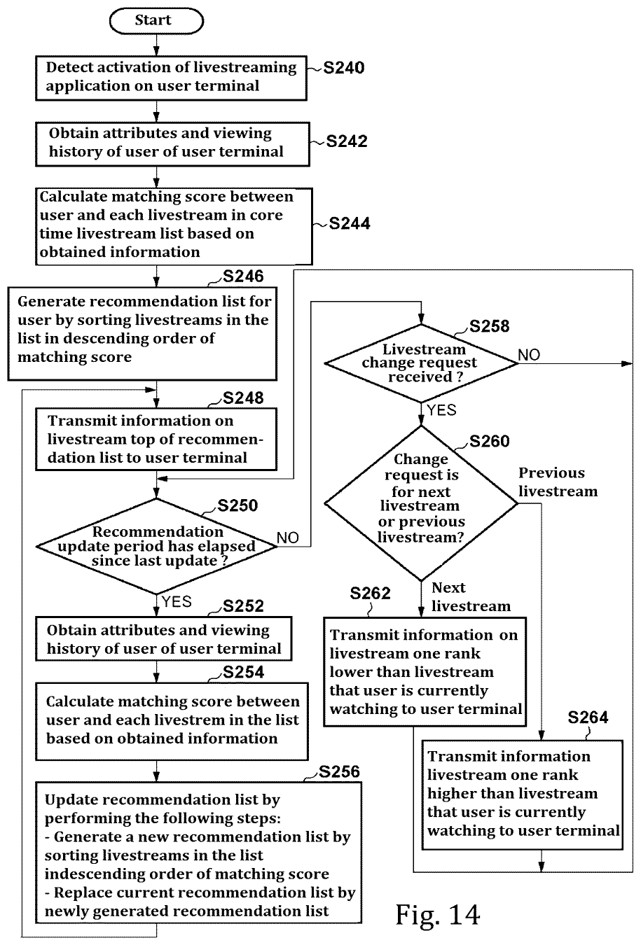

FIG. 14 is a flowchart showing a series of steps performed in the livestreaming system 1 when providing a livestream to the user terminal 30 of a viewer. The livestream information providing unit 302 detects activation of a livestreaming application on the user terminal of a user (S240). Upon a tap on an application icon of the livestreaming application on the user terminal display by the user, the livestreaming application is opened on the user terminal. When the start up of the livestreaming application has completed, the livestreaming application generates a startup signal including the user ID of the user of the user terminal and transmits it to the server 10 over the network NW. Upon reception of the startup signal, the server 10 detects the startup of the livestreaming application at the user terminal from which the startup signal was sent.

The matching unit 334 obtains the attributes and viewing history of the user of the user terminal (hereinafter referred to as “target user”) whose startup of the livestreaming application was detected in step S240 (S242). The matching unit 334 obtains, from the user DB 318, the attributes and level associated with the user ID included in the received startup signal. The matching unit 334 obtains the viewing history associated with the user ID from an unshown history holding unit. The matching unit 334 calculates a matching score between the target user and each livestream registered in the core time livestream list 338 based on the obtained information (S244).

The recommendation processing unit 336 generates a recommendation list for users including the target user or a recommendation list especially made for the target user by sorting the livestreams registered in the core time livestream list 338 in descending order of the matching scores, and registers the list in the recommendation list DB 340 (S246). The livestream information providing unit 302 transmits information on the livestream registered at the top in the recommendation list for the target user to the user terminal of the target user over the network NW (S248). In the embodiment, since the user terminal displays the livestreaming room screen of a recommended livestream as soon as the livestreaming application is started, so to achieve this, the livestream information providing unit 302 starts relaying the video data of the livestream at the top of the list.

The recommendation processing unit 336 determines whether the recommendation update period has elapsed since the last update of the recommendation list for the target user (S250). When the recommendation update period has elapsed (Y in S250), the process proceeds to steps of updating the recommendation list in steps S252, S254, and S256 described below. When the recommendation update period has not elapsed (N in S250), the process proceeds to step S258. This means that the recommendation list update interval is equal to or the same as the recommendation update period.

When the recommendation renewal period has elapsed (Y in S250), the matching unit 334 obtains the attributes and viewing history of the target user (S252). The matching unit 334 obtains the attributes and level associated with the user ID of the target user from the user DB 318. The matching unit 334 acquires the viewing history associated with the user ID from the unshown history holding unit. The matching unit 334 calculates a matching score between the target user and each livestream registered in the core time livestream list 338 based on the obtained information (S254).

The recommendation processing unit 336 updates the recommendation list for the target user by performing the following steps:
The recommendation processing unit 336 generates a new recommendation list for the target user by sorting the livestreams registered in the core time livestream list 338 in descending order of matching scores.
The recommendation processing unit 336 replaces the current recommendation list for the target user with the newly generated recommendation list generated. The recommendation processing unit 336 updates the recommendation list DB 340 so that such replacement is realized.

The process then returns to step S248.

When the recommendation update period has not elapsed (N in S250), the livestream information providing unit 302 determines whether the livestream change request has been received from the user terminal of the target user (S258). When the livestream change request has not been received (N in S258), the process returns to step S250. Whereas when the livestream change request is received (Y in S258), the livestream information providing unit 302 determines whether the received livestream change request is for the next livestream or the previous livestream (S260). In this embodiment, when the livestream change request is the swipe signal indicating swipe up, it is determined to be the livestream change request requesting the next livestream, and when the livestream change request is the swipe signal indicating swipe down, it is determined to be the livestream change request requesting the previous livestream.

When the livestream change request is for the next livestream (“next livestream” in S260), the relay unit 304 transmits information on a livestream one rank lower than the livestream that the target user is currently watching in the recommendation list for the target user to the target user's user terminal over the network NW (S262). Upon reception of the swipe signal indicating the swipe up from the user terminal of the target user, the relay unit 304 refers to the stream DB 314 and identifies the stream ID that includes, as the viewer ID, the user ID of the target user included in the swipe signal. The livestream identified by the identified stream ID is the livestream that the target user is currently watching. The relay unit 304 refers to the recommendation list DB 340 and obtains a stream ID placed one rank below the identified stream ID in the recommendation list for the target user. The relay unit 304 then starts to provide video data of the livestream identified by the obtained stream ID to the target user's user terminal. The relay unit 304 subsequently updates the stream DB 314 so that the user ID of the target user is included in the viewer IDs of the stream ID of the livestream started to be provided. The process then returns to step S250.

When the livestream change request is for the previous livestream (“previous livestream” in S260), the relay unit 304 transmits information on a livestream one rank higher than the livestream that the target user is currently watching in the recommendation list for the target user to the target user's user terminal over the network NW (S264). Upon reception of the swipe signal indicating the swipe down from the user terminal of the target user, the relay unit 304 refers to the stream DB 314 and identifies the stream ID that includes, as the viewer ID, the user ID of the target user included in the swipe signal. The livestream identified by the identified stream ID is the livestream that the target user is currently watching. The relay unit 304 refers to the recommendation list DB 340 and obtains a stream ID placed one rank higher than the identified stream ID in the recommendation list for the target user. The relay unit 304 then starts to provide video data of the livestream identified by the obtained stream ID to the target user's user terminal. The relay unit 304 subsequently updates the stream DB 314 so that the user ID of the target user is included in the viewer IDs of the stream ID of the livestream started to be provided. The process then returns to step S250.

As explained in the examples of FIGS. 5 and 9, a target user “VR1” is currently watching the livestream “ST1” as shown in FIG. 5. When the target user “VR1” swipes up, the relay unit 304 refers to the recommendation list DB 340 of FIG. 9 to identify the livestream “ST4”, which is one rank below the livestream “ST1” in the recommendation list for the target user “VR1”. The relay unit 304 stops relaying the livestream “ST1” to the user terminal of the target user “VR1” and subsequently starts relaying the livestream “ST4”. When the target user “VR1” swipes down, the relay unit 304 refers to the recommendation list DB 340 of FIG. 9 and identifies the livestream “ST1” that is one rank higher than the livestream “ST4” in the recommendation list for the target user “VR1”. The relay unit 304 stops relaying the livestream “ST4” to the user terminal of the target user “VR1” and subsequently starts relaying the livestream “ST1”.

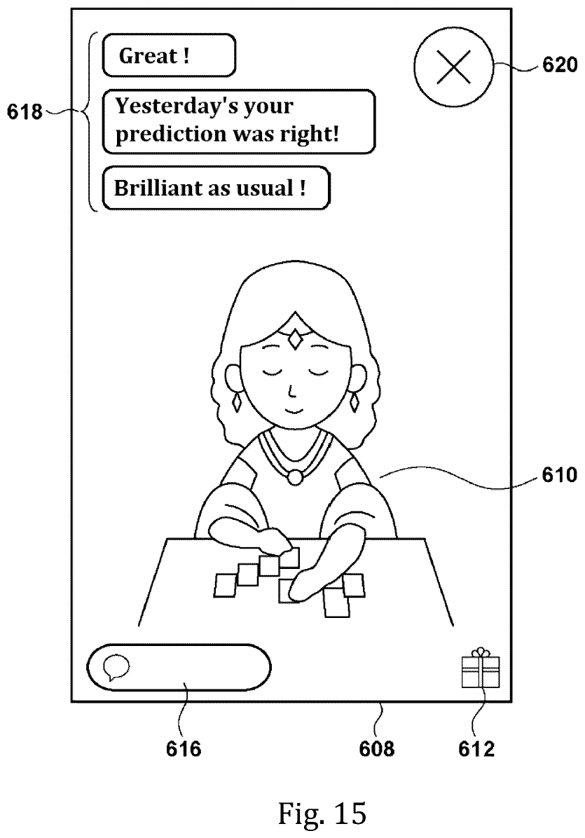

FIG. 15 is a representative screen image of a livestreaming room screen 608 on the display of the user terminal of the target user. When the livestreaming application is started on the user terminal of the target user and the user terminal receives the video data of the livestreaming at the top of the recommendation list from the server 10, the viewer-side UI control unit 202 of the user terminal generates and displays the livestreaming room screen 608 of FIG. 15 on the display. The livestreaming room screen 608 displays a video image generated by the user terminal 20 of the livestreamer in real time. The livestreaming room screen 608 includes a video image 610 of the livestreamer obtained by reproducing the video data received from the server 10, a gift object 612, a comment input region 616, a comment display region 618, and a quit viewing button 620. The viewer-side UI control unit 202 superimposes various objects such as the gift object 612, the comment input area 616, the comment display area 618, and the quit viewing button 620 on the video image 610 provided by reproducing the video data, to generate the livestreaming room screen 608.

The comment input region 616 receives a comment input by the viewer. The viewer-side communication unit 204 generates a comment input signal that includes the comment entered in the comment input region 616, and transmits the signal to the server 10 over the network NW. At the same time, the viewer-side UI control unit 202 updates the comment display region 618 to display the comment entered in the comment input region 616.

The quit viewing button 620 is an object for accepting an instruction from the viewer to quit viewing the livestream.

When the viewer-side UI control unit 202 detects swipe up or swipe down on the livestreaming room screen 608, it generates a swipe signal that includes the direction of the detected swipe and the user ID of the target user. The viewer-side communication unit 204 transmits the generated swipe signal to the server 10 over the network NW.

When the viewer UI control unit 202 detects swipe left or swipe right on the livestreaming room screen 608, it stops displaying the livestreaming room screen 608 and displays the livestream selection screen on the display instead. Alternatively, the viewer-side UI control unit 202 causes the display to transition from the live streaming room screen 608 to the livestream selection screen.

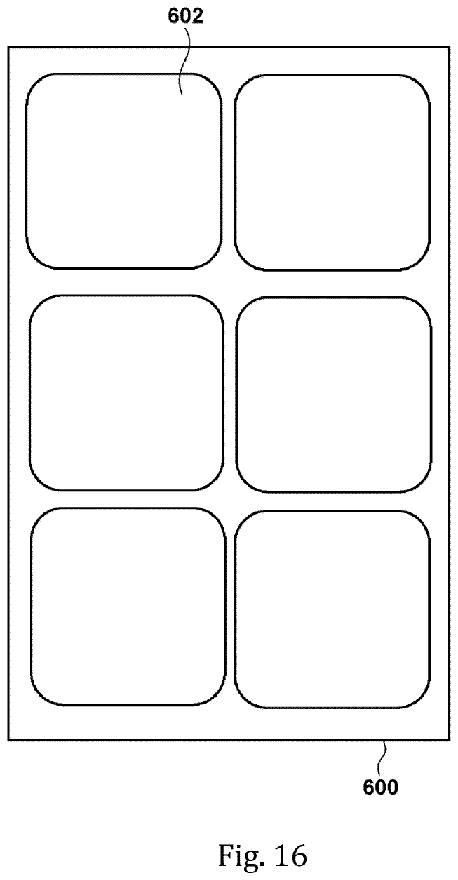

FIG. 16 is a representative screen image of the livestream selection screen on the display of the user terminal of the target user. The livestream selection screen 600 includes thumbnails 602 indicating livestreams in the list of currently available livestreams received from the server 10. This list of currently available livestreams includes livestreams that are not in the core time and livestreams that are in the core time. This list may be generated based on the matching scores between the target user and the livestreams, without considering whether each livestream is in the core time. The viewer-side UI control unit 202 generates the live-stream selection screen 600 based on the list of live-streams obtained from the server 10 and shows the screen on the display. When a viewer taps on one of the thumbnails 602, the screen changes to the livestreaming room screen of the corresponding livestream.

In this embodiment, in order to watch a livestream that is not in the core time, it is necessary to swipe left or right on the livestreaming room screen of the livestream that is in the core time and first displayed after starting the livestreaming application to display the livestream selection screen, and then tap the thumbnail of the livestream that is not in the core time on the selection screen. Thus, viewing the livestreams that are not in the core time is configured to require more effort than viewing the livestreams that are in the core time.

In the above embodiment, an example of the database (DB) is a hard disk or semiconductor memory, for example. It will be understood by those skilled in the art that each element or component can be realized by a CPU not shown, a module of an installed application program, a module of a system program, or a semiconductor memory that temporarily stores the contents of data read from a hard disk, and the like.

According to the livestreaming system 1, the livestreamer is able to specify when his/her livestream will be on the recommendation lists for potential viewers by pressing the core time button. This allows the livestreamer to gain exposure to more the potential viewers at the timing when his/her livestream becomes more attractive, so that more viewers can join and stay in his/her livestream. As a result, interaction with viewers is invigorated and the satisfaction of the livestreamer is increased. In addition, viewers will be able to enjoy livestreams more because they can watch more attractive livestream one after another with easy operations.

In addition, in the livestreaming system 1, a limit is set for the core time, and a predetermined interval is also set between the core times. Thus, it is possible to suppress overuse of the core time and provide the benefit of the core time to more livestreamers.

In addition, the livestreaming system 1 extends the core time and adjusts the length of the waiting period depending on the payment of the price by the viewer or livestreamer and the parameters of the livestream. Thus, it can provide the viewers and/or livestreamers with the freedom and incentive to adjust their exposure.

In the livestreaming system 1, the livestreams that are in the core time are provided to viewers in the style of so-called reels, and presses of the core time button by the livestreamers are reflected in the list of reels in real time. Therefore, it is possible to increase the satisfaction of the livestreamers by reducing the time lag between the instruction to start the core time and the increase of exposure, and to attract viewers by providing them with highly attractive livestreams one after another in the reel style.

### Second Embodiment

There has been known one type of gift in which effects are randomly selected (see, for example, Japanese Patent No. 7426156 (“the '156 Patent”)). This type of gifts can make livestreams more exciting by the anticipation of winning.

However, random gifts such as those described in the '156 Patent are subject to probability, and in some cases, the viewer does not win even after hundreds or thousands of uses. If the viewer feels that a chance of winning is too small, the viewer's enjoyment of using the gift is diminished.

The second embodiment was made in light of these issues, and one object is to provide a technology that can enhance the effectiveness of the random gifts used in livestreams. According to the aspect of the second embodiment, the effectiveness of the random gifts in livestreams can be enhanced.

In the livestreaming system of the second embodiment, viewers participating in a livestream in progress can give a random gift to the livestreamer of the livestream. The random gift is a digital item that a viewer spends points to use. When the random gift is used, a lottery is conducted according to a predetermined lottery algorithm, and a reward in an amount determined by the lottery result is given to the livestreamer. In this embodiment, a ceiling relief function is provided for the random gifts in all counts in the application.

For example, the lottery algorithm is configured such that if the random gift is used (X−1) times by all users in the application (X can be any natural number greater than or equal to two) and no wins occurs in all of the (X−1) times, a win always occurs when the random gift is used at the Xth time. The count is reset after a win occurs. For example, the probability of winning and losing the lottery in 1st to (X−1) times of uses of the random gift is set as follows:
Lose: 99%
Win: 1%.
The probability at the Xth use of the gift after keep losing in the (X−1) times uses:
Lose: 0%
Win: 100%

The random gifts are subject to the probability, and in some cases, the users do not win even after hundreds or thousands of uses. If viewers feel that a chance of winning is too small, the viewers' enjoyment of using the gifts is diminished. By setting a ceiling value for the number of times users lose (or no-winning) in a row in this embodiment, it is guaranteed that winning occurs in a cycle of the ceiling value, which will be the maximum number of times the viewers use the gifts to win. Thus, the system can provide a more enjoyable livestreaming service by motivating the viewers to use the random gifts. Moreover, in the embodiment, the system counts the total number of loses in the application, on the server, or across all users registered on the livestreaming platform, and establishes the ceiling value for the total number of loses. When the total number of loses approaches the ceiling value, the mood to throw the random gifts will be increased on the entire livestreaming platform, and demands for the use of random gifts will increase and livestreams become more exciting. This system allows users of any tire, including VIPs, newcomers, and middle-tiers, to win the random gift ceiling, so that even low to mid-tiers, who usually use relatively small amounts of gifts, will participate in the competition for the random gift ceiling and enjoy the excitement and fun.

A livestreaming system 1001 relating to the second embodiment has the same configuration as the livestreaming system 1 shown in FIG. 2. A user terminal 1020 of a livestreamer and a user terminal 1030 of a viewer in the livestreaming system 1001 have the same configuration as the user terminal 20 shown in FIG. 3.

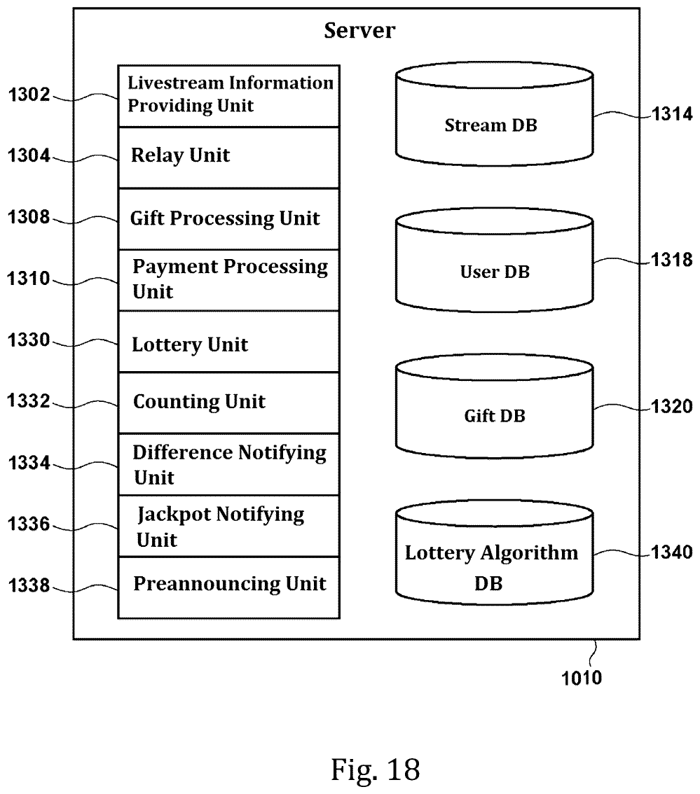

FIG. 18 is a block diagram showing functions and configuration of a server 1010 relating to the second embodiment. The server 1010 includes a livestreaming information providing unit 1302, a relay unit 1304, a gift processing unit 1308, a payment processing unit 1310, a stream DB 1314, a user DB 1318, a gift DB 1320, a lottery unit 1330, a counting unit 1332, a difference notifying unit 1334, a jackpot notifying unit 1336, a preannouncing unit 1338, and a lottery algorithm DB 1340.

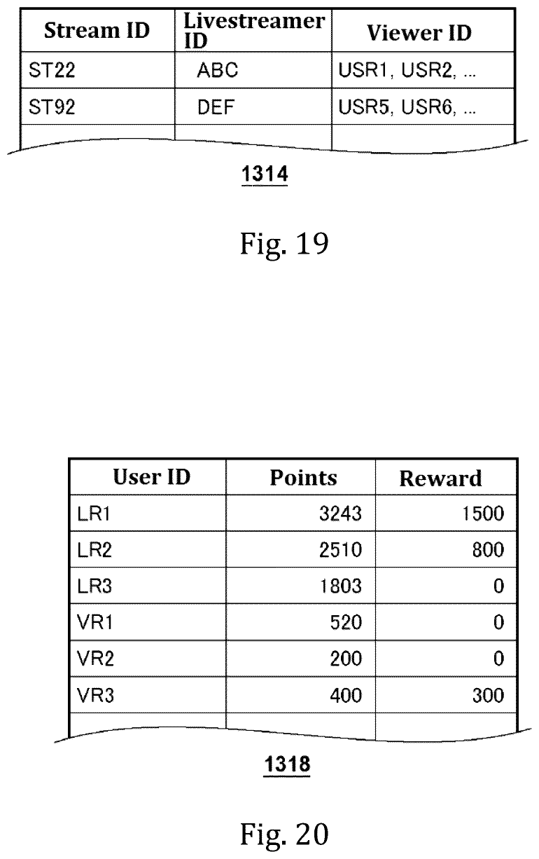

FIG. 19 is a data structure diagram showing an example of the stream DB 1314 of FIG. 18. The stream DB 1314 holds information regarding livestreams currently taking place. The stream DB 1314 stores a stream ID identifying a livestream on a livestreaming platform provided by the livestreaming system 1001, a livestreamer ID, which is a user ID identifying the livestreamer who provides the livestream, and a viewer ID, which is a user ID identifying a viewer of the livestream, in association with each other.

In the livestreaming platform provided by the livestreaming system 1001 of the embodiment, when a user delivers a livestream, the user is referred to as a livestreamer, and when the same user views a livestream delivered by another user, the user is referred to as a viewer. Therefore, the distinction between a livestreamer and a viewer is not fixed, and a user ID registered as a livestreamer ID at one time may be registered as a viewer ID at another time.

FIG. 20 is a data structure diagram showing an example of the user DB 1318 of FIG. 18. The user DB 1318 holds information regarding users. The user DB 1318 stores a user ID for identifying a user, points held by the user, and a reward given to the user, in association with each other.

The points are an electronic representation of value circulated in the livestreaming platform. Users are able to purchase points by credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

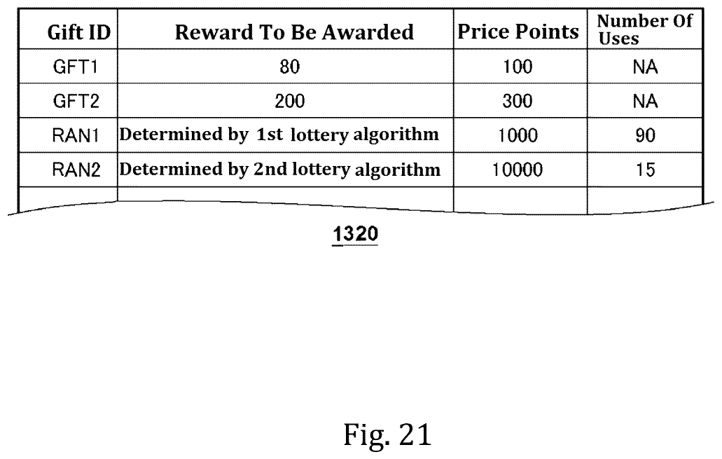

FIG. 21 is a data structure diagram showing an example of the gift DB 1320 of FIG. 18. The gift DB 1320 holds information regarding gifts available for the viewers in relation to the livestreaming. A gift is electronic data or digital item with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be purchased and then used at any time later by the purchaser viewer.
When a viewer gives a gift to a livestreamer, the livestreamer is awarded a corresponding reward.
When a gift is used, the use may trigger an effect associated with the gift. For example, an effect corresponding to the gift will appear on the livestreaming room screen.

The gift DB 1320 stores: a gift ID identifying a gift; a reward to be awarded, which is a reward awarded to a livestreamer when the gift is given to the livestreamer; price points, which is the amount of points to be paid for use of the gift; and if the gift is a random gift, the number of times the gift is used, in association with each other. A viewer is able to give a desired gift to a livestreamer by paying the price points of the desired gift while viewing the livestream. The payment of the price points may be made by an appropriate electronic payment means. For example, the payment may be made by the viewer paying the price points to the administrator. Alternatively, bank transfers or credit card payments may be used. The administrator can freely determine the relationship between the reward to be awarded and the price points. For example, the administrator may determine that the reward to be awarded=the price points. Alternatively, points obtained by multiplying the granted reward by a predetermined coefficient such as 1.2 may be set as the price points, or points obtained by adding predetermined fee points to the granted reward may be set as the price points.

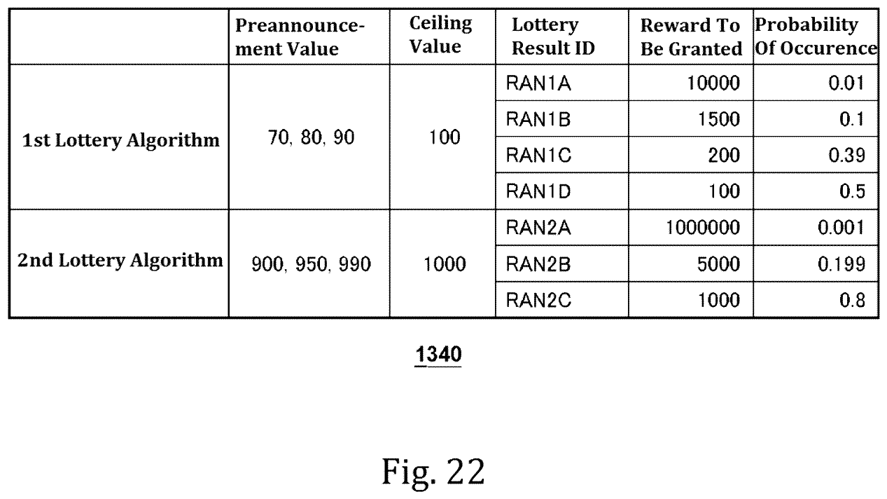

In addition to regular gifts (“GFT1” and “GFT2”), the system in this embodiment has two types of random gifts (“RAN1” and “RAN2”) that are different from the regular gifts. The random gifts are gifts in which the amount of reward given to the livestreamer is determined by lottery. When the gift “RAN1” is used, 1000 points are subtracted from the points owned by the viewer who has used the gift, and drawing is held according to a first lottery algorithm. The drawing results in 100, 200, 1500 or 10000 points to be given, to the livestreamer (described later with reference to FIG. 22). Of the 100, 200, 1500, and 10000 points, 10000 points is the largest amount, and the lottery result corresponding to this largest amount of 10000 points is referred to as jackpot for the random gift “RAN1”. The lottery result associated with each of the remaining 100, 200, and 1500 points is referred to as non-jackpot for the random gift “RAN1”.

When the gift “RAN2” is used, 10000 points are subtracted from the points owned by the viewer who has used the gift, and drawing is conducted according to a second lottery algorithm. The drawing results in 1000, 5000 or 1000000 points to be given to the livestreamer (described later with reference to FIG. 22). Of the 1000, 5000, and 1000000 points, 1000000 points is the largest amount, and the lottery result corresponding to this largest amount of 1000000 points is referred to as jackpot for the random gift “RAN2”. The lottery result associated with each of the remaining 1000 and 5000 points is referred to as non-jackpot for the random gift “RAN2”.

The number of times a random gift is used is a value obtained by counting the number of times the random gift is used with reference to the time when a jackpot is selected among the multiple lottery results of the random gift. The number of times the random gift is used is incremented by one when the random gift is used and the lottery result is a non-jackpot, and the number of times is reset to 0 when the jackpot is hit. The number of times indicates the number of consecutive occurrences of the non-jackpot. The average or statistically representative value of the number of times the gift is used is inversely proportional to the frequency of the jackpot.

FIG. 22 is a data structure diagram showing an example of a lottery algorithm DB 1340 in FIG. 18. The lottery algorithm DB 1340 holds lottery algorithms for the random gifts. The lottery algorithm DB 1340 holds, for each lottery algorithm, a preannouncement value, a ceiling value, a lottery result ID identifying a lottery result, a reward to be granted corresponding to the lottery result, and the probability of occurrence of the lottery result. The lottery algorithm is configured so that when the number of times the random gift is used reaches the ceiling value, jackpot is selected among the multiple lottery results of the random gift.

The preannouncement value includes one or more values that are smaller than the ceiling value. When the number of times the random gift is used reaches or exceeds the corresponding preannouncement value, a preannouncement is sent to the users of the livestreaming platform to inform that the ceiling for that random gift is close.

The ceiling value is a value set by the administrator of the livestreaming platform for each random gift, and is independent of either the livestreamers or the viewers. In other words, there is only one ceiling value for each random gift on the livestreaming platform. In other words, the same ceiling value applies to all users at the same time. When the number of times the random gift is used reaches the corresponding ceiling value, the jackpot is definitively selected as the result of the lottery.

The lottery result ID identifies the lottery result according to the corresponding lottery algorithm. In the example of FIG. 22, one of four lottery results “RAN1A”, “RAN1B”, “RAN1C”, and “RAN1D” is selected according to the first lottery algorithm (corresponding to the random gift “RAN1”). Here, “RAN1A” is the jackpot, “RAN1B”, “RAN1C”, and “RAN1D” are the non-jackpot results. The “RAN1A”, “RAN1B”, “RAN1C”, and ‘RAN1D’ are selected with a probability of 0.01, 0.1, 0.39, and 0.5, respectively. However, when the number of times the random gift is used reaches the ceiling value of “100”, the jackpot “RAN1A” is selected definitively. The “RAN1A”, “RAN1B”, “RAN1C”, and “RAN1D” have the effect of granting the livestreamer 10000, 1500, 200, and 100 points, respectively.

Referring again to FIG. 18, upon reception of a notification from the user terminal 1020 of a livestreamer that the livestreamer starts a livestream over the network NW, the livestream information providing unit 302 enters in the stream DB 1314 a stream ID identifying this livestream and the livestreamer ID of the livestreamer who delivers the livestream. When the livestream information providing unit 1302 receives a request for information about livestreams from the out-of-livestream communication unit of a user terminal of an active user over the network NW, the livestream information providing unit 302 refers to the stream DB 1314 and makes a list of currently available livestreams. The livestream information providing unit 1302 transmits the generated list to the requesting user terminal over the network NW. The out-of-livestream UI control unit of the requesting user terminal generates a livestream selection screen based on the received list and shows the livestream selection screen on the display of the user terminal.

Once the out-of-livestream UI control unit of the user terminal receives the active user's selection of the livestream on the livestream selection screen, the out-of-livestream UI control unit 402 generates a livestream request including the stream ID of the selected livestream, and transmits the livestream request to the server 1010 over the network NW. The livestream information providing unit 1302 starts to provide, to the requesting user terminal, the livestream identified by the stream ID included in the received livestream request. The livestream information providing unit 1302 updates the stream DB 1314 such that the user ID of the active user of the requesting user terminal is included in the viewer IDs associated with the stream ID. In this way, the active user can be a viewer of the selected livestream.

The relay unit 1304 relays the video data from the livestreamer-side user terminal 1020 to the viewer-side user terminal 1030 in the livestream started by the livestream information providing unit 1302. The relay unit 1304 receives from the viewer-side communication unit of the user terminal 1030 of a viewer over the network NW, a signal that represents user input by the viewer during the livestream or reproduction of the video data. The signal that represents user input may be an object specifying signal for specifying an object displayed on the display of the user terminal 1030, and the object specifying signal includes the viewer ID of the viewer, the livestreamer ID of the livestreamer delivering the livestream that the viewer watches, and an object ID that identifies the object. When the object is a gift icon, the object ID is a gift ID. The object specifying signal in that case is a gift use signal indicating that the viewer uses a gift for the livestreamer. Similarly, the relay unit 1304 receives from the livestreamer-side communication unit of the livestreaming unit in the user terminal 1020, a signal that represents user input by the livestreamer during reproduction of the video data, such as an object specifying signal.

The gift processing unit 1308 updates, for the normal gift, the user DB 1318 so as to increase the reward of the distributor depending on a granted reward of the gift identified by the gift ID included in the object specifying signal. Specifically, the gift processing unit 1308 refers to the gift DB 1320 to specify a reward to be awarded for the gift ID included in the received gift use signal. The gift processing unit 1308 then updates the user DB 1318 to add the specified reward to be awarded to the reward for the livestreamer ID included in the gift use signal. A process related to the random gifts will be described later in detail.

The payment processing unit 1310 processes payment of a price of the gift by the viewer in response to reception of the gift use signal. Specifically, the payment processing unit 1310 refers to the gift DB 1320 to specify the price points of the gift identified by the gift ID included in the gift use signal. The payment processing unit 1310 then updates the user DB 1318 to subtract the specified price points from the points of the viewer identified by the viewer ID included in the gift use signal.

Upon reception of the gift use signal indicating the use of the random gift, the lottery unit 1330 selects one lottery result from among a plurality of lottery results, each corresponding to a different amount of reward, in accordance with the lottery algorithm. For example, when the gift use signal indicates the use of the random gift “RAN1”, the lottery unit 1330 refers the gift DB 1320 and determines that the lottery will be drawn according to the first lottery algorithm. The lottery unit 1330 refers to the lottery algorithm DB 1340 and then draws a lottery according to the first lottery algorithm to select one lottery result from among “RAN1A”, “RAN1B”, “RAN1C”, and “RAN1D”. The gift processing unit 1308 grants a reward corresponding to the selected lottery result to the livestreamer of the livestream for which the random gift has been used. The gift processing unit 1308 updates the user DB 1318 to increase the livestreamer's reward according to the granted reward corresponding to the selected lottery result. The gift processing unit 1308 updates the user DB 1318 to add the granted reward corresponding to the selected lottery result to the reward associated with the livestreamer ID that is included in the gift use signal indicating the use of the random gift.

The counting unit 1332 counts the number of times each random gift is used with reference to the last time when a jackpot is selected among the multiple lottery results of the random gift. The counting unit 1332 counts the number of times each random gift is used, independent of viewers who used the random gift and independent of the livestreamers of the livestreams in which the random gift was used. In other words, the counting unit 1332 counts the number of times each random gift is used across the livestreaming platform provided by the server 1010. The counting unit 1332 updates the number of times of the random gift use held in the gift DB 1320 in response to receipt of the gift use signal indicating use of the random gift. When the counting unit 1332 receives the gift use signal, it updates the gift DB 1320 to add one (1) to the number of uses corresponding to the gift ID of the random gift included in the gift use signal. When a jackpot is selected as a result of the random gift drawing, the counting unit 1332 resets the number of times that random gift is used to zero (0). When the jackpot of the random gift is selected, the counting unit 1332 updates the gift DB 1320 so that the number of uses corresponding to the gift ID of the random gift is set to zero.

The difference notification unit 1334 notifies the user terminal of the user of the livestreaming platform provided by the server 1010 of information indicating a difference between the number of time each random gift is used and the ceiling value for each random gift. The difference notification unit 1334 notifies the entire livestreaming platform provided by the server 1010 of the difference value between the number of uses of the random gift and its ceiling value by displaying the difference value associated with the icon of the random gift on the user terminal. Upon receipt of the gift information request from the user terminal, the server 1304 refers to the gift DB 1320 to specify gift IDs of available gifts. At the same time, the difference notification unit 1334 calculates differences between the number of uses and the ceiling value for the gift IDs of the random gifts among the identified gift IDs. The relay unit 1304 generates gift information including the identified gift IDs and the calculated difference values (in the case of the random gifts) and transmits it to the requesting user terminal.

In this embodiment, the system is configured so that all users can obtain the notification containing information indicating the difference between the number of times each random gift is used and the corresponding ceiling value. Alternatively, in other embodiments, the information indicating the difference may be provided only to some users who meet certain conditions, such as users registered as VIPs, users registered as top livestreamers, users who have contracted with the administrator, and newly registered users. When the notification is provided only to such a subset of users, this may increase the sense of specialness for users in the segment to which the notification is provided, and may encourage users to take action to enter this segment.

The jackpot notifying unit 1336 transmits a jackpot notification to the user terminals of the users on the livestreaming platform provided by the server 1010 on one of the conditions that the jackpot was selected in a drawing of the random gift. The jackpot notifying unit 1336 transmits the jackpot notification in a different manner between when the jackpot is selected due to the number of uses reaching the ceiling value and when the jackpot is selected by a normal lottery drawing. The jackpot notifying unit 1336 notifies the users on the livestreaming platform that the random gift hit the jackpot by means of a ticker field on the livestream screen, a system comment provided by the system during the livestream, an in-app message, or a push notification.

The system may be configured so that all users can obtain the notification that the jackpot has been hit on the random gift, or it may be configured so that the notification is provided only to some users who meet certain conditions, such as users registered as VIPs, users registered as top livestreamers, users who have contracted with the administrator, and newly registered users.

On one condition that the number of times a random gift is used has reached the corresponding preannouncement value, the preannouncing unit 1338 notifies the user terminals of the users on the livestreaming platform provided by the server 1010 about the random gift. The preannouncing unit 1338 notifies the users on the livestreaming platform that the ceiling for the random gift is close by means of via a ticker field on the livestream screen, a system comment provided by the system during the livestream, an in-app message, or a push notification.

The system may be configured so that all users can obtain the notification that the ceiling for the random gift is close, or it may be configured so that the notification is provided only to some users who meet certain conditions, such as users registered as VIPs, users registered as top livestreamers, users who have contracted with the administrator, and newly registered users.

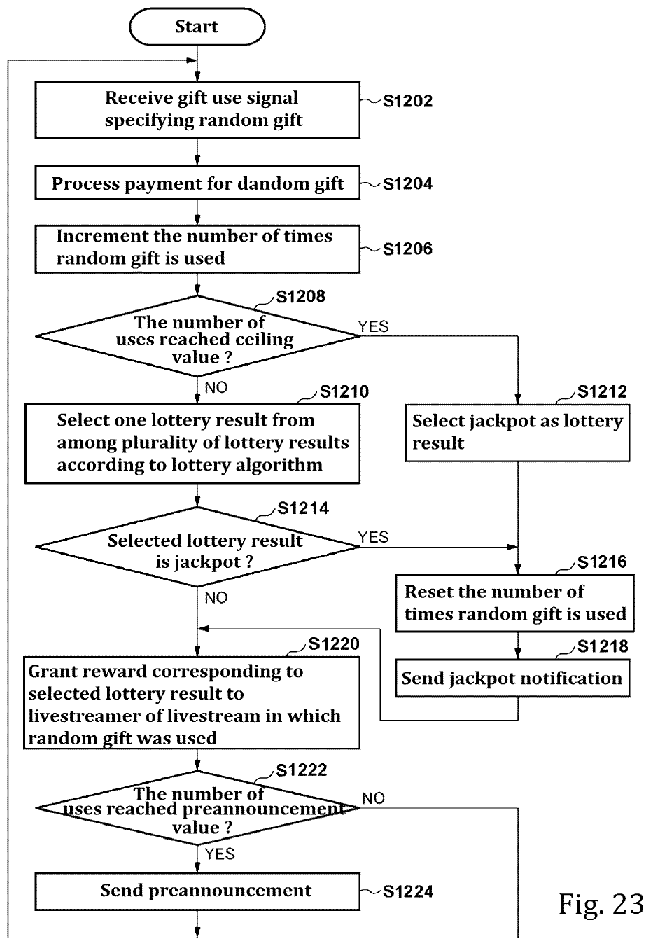

The operation of the livestreaming system 1001 with the above configuration will be now described. FIG. 23 is a flow chart showing a series of steps of a process performed in the live-streaming system 1001 when a viewer uses a random gift during a livestream. The relay unit 1304 receives the gift use signal specifying the random gift from the user terminal 1030 of the viewer of the livestream currently in progress (S1202). The payment processing unit 1310 processes payment for the random gift by the viewer (S1204). The payment processing unit 1310 refers to the gift DB 1320 to specify the price points for the random gift specified by the gift use signal received in step S1202 (hereinafter referred to as “specified random gift”). The payment processing unit 1310 then updates the user DB 1318 to subtract the specified price points from the points of the viewer identified by the viewer ID included in the gift use signal.

The counting unit 1332 increments the number of times the specified random gift is used (S1206). The lottery unit 1330 refers to the gift DB 1320 and specifies the lottery algorithm corresponding to the specified random gift. The lottery unit 1330 refers to the lottery algorithm DB 1340 and finds the ceiling value of the specified lottery algorithm. The lottery unit 1330 determines whether the number of uses incremented in step S1206 has reached the ceiling value (S1208). When it has not reached the ceiling value (N in S1208), the lottery unit 1330 selects one lottery result from among the plurality of lottery results according to the lottery algorithm specified in step S1208 (S1210). Whereas when the number of uses reaches the ceiling value (Y in S1208), the lottery unit 1330 selects the jackpot as the lottery result (S1212).

When the lottery result selected in step S1210 is the jackpot (Y in S1214), or when the jackpot lottery result is selected in step S1212, the counting unit 1332 resets the number of times the specified random gift is used to zero (S1216). The jackpot notifying unit 1336 sends the jackpot notification to the user terminals of all the participants in the livestreams (livestreams and viewers) provided through the livestreaming platform (S1218). The jackpot notification indicates that who used the specified gift that hits the jackpot and the specified gift is used in which livestreamer's livestream. The jackpot notification includes information indicating whether the jackpot was selected by reaching the ceiling value, the gift ID identifying the specified random gift, the stream ID of the livestream in which the specified random gift was used, the user ID of the livestreamer of the livestream, and the user ID of the viewer who used the specified random gift. A jackpot notification when the jackpot is selected by reaching the ceiling value is referred to as a ceiling jackpot notification.

The gift processing unit 1308 grants a reward corresponding to the lottery result selected in step S1210 or the lottery result selected in step S1212 to the livestreamer of the livestream in which the specified random gift was used (S1220). The gift processing unit 1308 transmits the selected lottery result to the user terminal of the livestreamer of the livestream in which the specified random gift was used and the user terminals of the viewers over the network NW.

The preannouncing unit 1338 refers to the lottery algorithm DB 1340 and specifies the preannouncement value of the specified lottery algorithm specified in step S1208. The preannouncing unit 1338 determines whether the number of times the specified random gift is used has reached the specified preannouncement value (S1222). When it has not reached yet (N in S1222), the process returns to the step S1202. When the number of uses reaches the preannouncement value (Y in S1222), the preannouncing unit 1338 transmits the preannouncement to the user terminals of all users logged into the livestreaming platform, indicating that the number of time the specified random gift is used is close to the ceiling value (S1224). The preannouncement includes the gift ID identifying the specified random gift and a difference between the ceiling value of the specified random gift and the preannouncement value reached this time. The process then returns to step S1202.

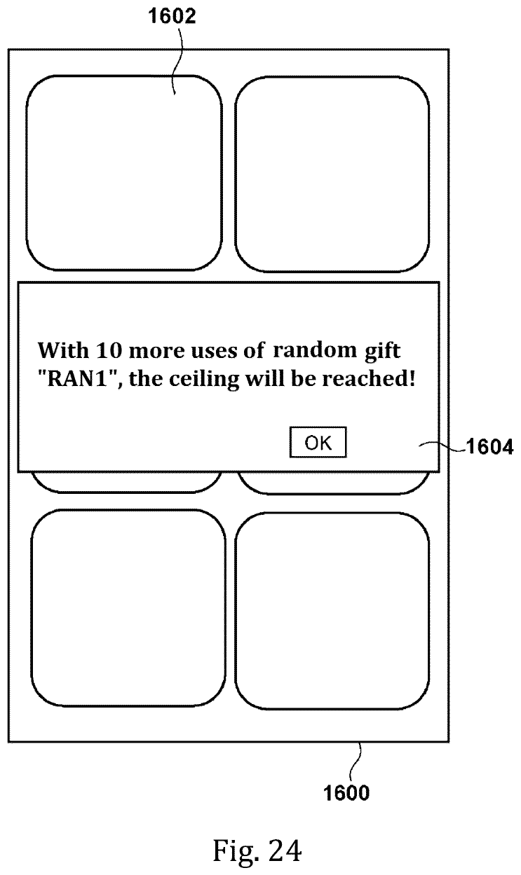

FIG. 24 is a representative screen image of a livestream selection screen 1600 on a user terminal display of an active user. The livestream selection screen 1600 includes thumbnails 1602 indicating livestreams in the list of currently available livestreams received from the server 1010. The out-of-livestream UI control unit generates the livestream selection screen 1600 based on the list of livestreams obtained from the server 1010 and shows the screen on the display.

Once the out-of-livestream UI control unit receives the preannouncement from the server 1010 while the livestream selection screen 1600 is shown on the display, it superimposes a ceiling preannouncement display region 1604, which shows the contents of the preannouncement, on the livestream selection screen 1600. The ceiling preannouncement display region 1604 may be a pop-up displaying the name of the random gift identified by the gift ID included in the preannouncement and a number indicating the difference between the ceiling value and the preannouncement value included in the preannouncement.

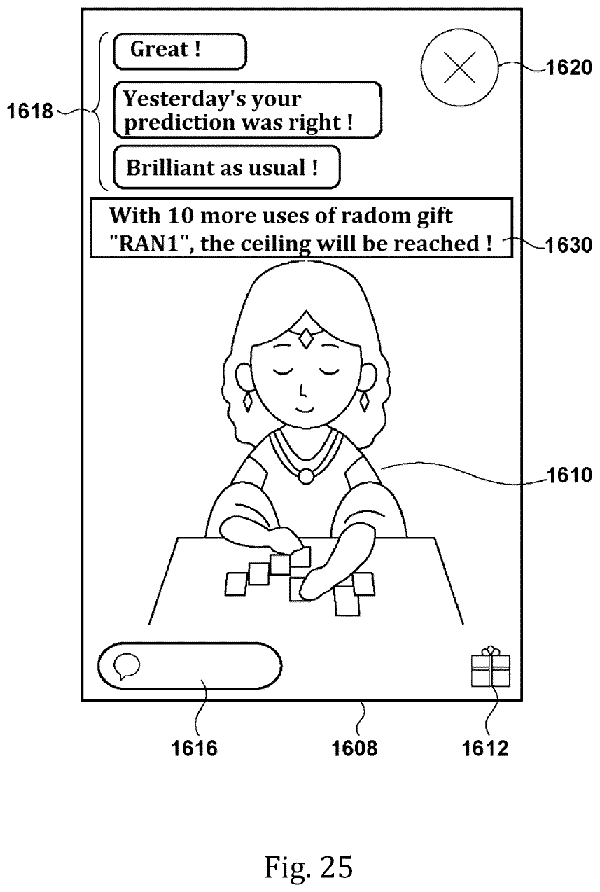

FIG. 25 is a representative screen image of a livestreaming room screen 1608 shown on the display of the viewer's user terminal 1030. Once the viewer taps one of the thumbnails 1602 on the live-stream selection screen 1600 of FIG. 24, the live-streaming room screen 1608 of FIG. 25 is shown on the display. The livestreaming room screen 1608 displays a video image generated by the user terminal 1020 of the livestreamer in real time. The livestreaming room screen 1608 includes a video image 1610 of a livestreamer obtained by reproducing the video data received from the server 1010, a gift object 1612, a comment input region 1616, a comment display region 1618, and a quit viewing button 1620. The viewer-side UI control unit superimposes various objects such as the gift object 1612, the comment input area 1616, the comment display area 1618, and the quit viewing button 1620 on the video image 1610 provided by reproducing the video data, to generate the livestreaming room screen 1608.

The comment display region 1618 may include a comment entered by the viewer and comments entered by other viewers, and notifications from the system. The notifications from the system may include information who gave which gift to the livestreamer. The viewer-side UI control unit generates the comment display region 1618 including comments of other viewers and received from the server 1010 and notifications from the system, and the viewer-side UI control unit 202 includes the generated comment display region 1618 in the livestreaming room screen 1608.

The comment input region 1616 receives a comment input by the viewer. The viewer-side communication unit generates a comment input signal that includes the comment entered in the comment input region 1616, and transmits the signal to the server 1010 over the network NW. At the same time, the viewer-side UI control unit updates the comment display region 1618 to display the comment entered in the comment input region 1616.

The quit viewing button 1620 is an object for accepting an instruction from the viewer to quit viewing the livestream.

Upon reception of the preannouncement from the server 1010 while the livestreaming room screen 1608 is shown on the display, the out-of-livestream UI control unit superimposes a ceiling preannouncement display region 1630, which shows the contents of the preannouncement, on the livestreaming room screen 1608. The ceiling preannouncement display region 1630 may be a ticker field displaying the name of the random gift identified by the gift ID included in the preannouncement and a number indicating the difference between the ceiling value and the preannouncement value included in the preannouncement. The viewer-side UI control unit may display a system comment indicating the contents of the preannouncement in the comment display region 1618 instead of or in addition to the ceiling preannouncement display region 1630.

When a tap on the gift object 1612 or the ceiling preannouncement display region 1630 is detected, the viewer-side UI control unit of the user terminal 1030 generates a gift information request and transmits the request to the server 1010 over the network NW. Upon receipt of the gift information request, the relay unit 1304 of the server 1010 refers to the gift DB 1320 and specifies available gift IDs. At the same time, the difference notification unit 1334 calculates differences between the number of uses and the ceiling value for the gift IDs of the random gifts among the identified gift IDs. The relay unit 1304 generates gift information including the identified gift IDs and the calculated difference values (in the case of the random gift) and transmits it to the requesting user terminal 1030. The viewer-side UI control unit of the user terminal 1030 generates a gift region 1622 for receiving selection of the gift based on the received gift information. The gift region 1622 includes a gift object 1624 of the gift specified by the gift ID included in the gift information. The viewer-side UI control unit displays the generated gift region 1622 on the livestreaming room screen 1608.

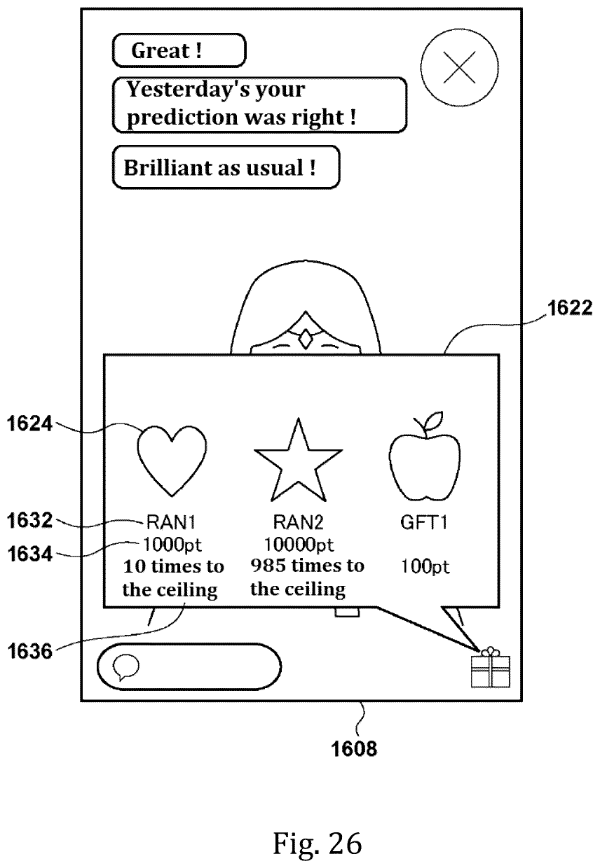

FIG. 26 is a representative screen image of the livestreaming room screen 1608 on which the gift region 1622 is superimposed on the display of the viewer's user terminal 1030. The gift region 1622 includes the gift object 1624 of the gift, the gift ID or name 1632 of the gift, price points 1634 for the gift, and a difference value 1636 between the ceiling value and the number of times the gift is used in case of the random gift.

Once a viewer taps the gift object 1624 of the random gift “RAN1” shown in the gift region 1622 on the livestreaming room screen 1608 of FIG. 26, the viewer-side UI control unit of the user terminal 1030 accepts the selection of the random gift by the viewer. The viewer-side communication unit generates the gift use signal including the gift ID of the specified random gift and transmits it to the server 1010. The viewer-side communication unit receives a lottery result of the specified random gift at the server 1010 from the server 1010 over the network NW. The viewer-side UI control unit generates an effect corresponding to the received lottery result. The viewer-side UI control unit displays the generated effect on the livestreaming room screen 1608. In this embodiment, different effects are provided for each of the three types of lottery results: jackpot by reaching the ceiling value, jackpot not reaching the ceiling value, and non-jackpot. The effect of the jackpot by reaching the ceiling value (hereinafter referred to as “ceiling jackpot”) is more splendid than the effect of the jackpot by drawing the lottery (hereinafter referred to simply as “jackpot”). The splendidness of an effect is defined by the duration of the effect, the number of effects displayed, whether the effect is still or animated, the size of the effect, whether it has sound effects or not, the quality of the effect, the appearance of the effect, how flashy the effect is, and so on. The jackpot effect is more splendid than the non-jackpot effect.

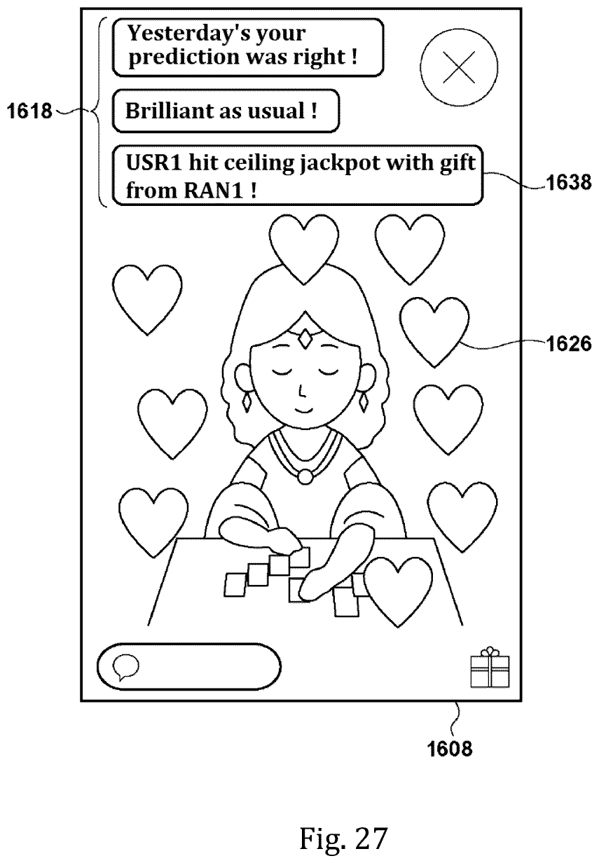

FIG. 27 is a representative screen image of the livestreaming room screen 1608 on which the ceiling jackpot effect 1626 is superimposed on the display of the viewer's user terminal 1030. In the example of FIG. 27, the ceiling jackpot effect 1626 includes nine hearts. The comment display region 1618 includes a system message 1638 indicating that the viewer (user “USR1” in the example of FIG. 27) gave a random gift (“RAN1” in the example of FIG. 27) and hit the ceiling jackpot. By seeing the ceiling jackpot effect 1626 and/or the system message 1638, the viewer can tell that the viewer wins the ceiling jackpot for the random gift “RAN1” in the livestream that he/she is currently watching.

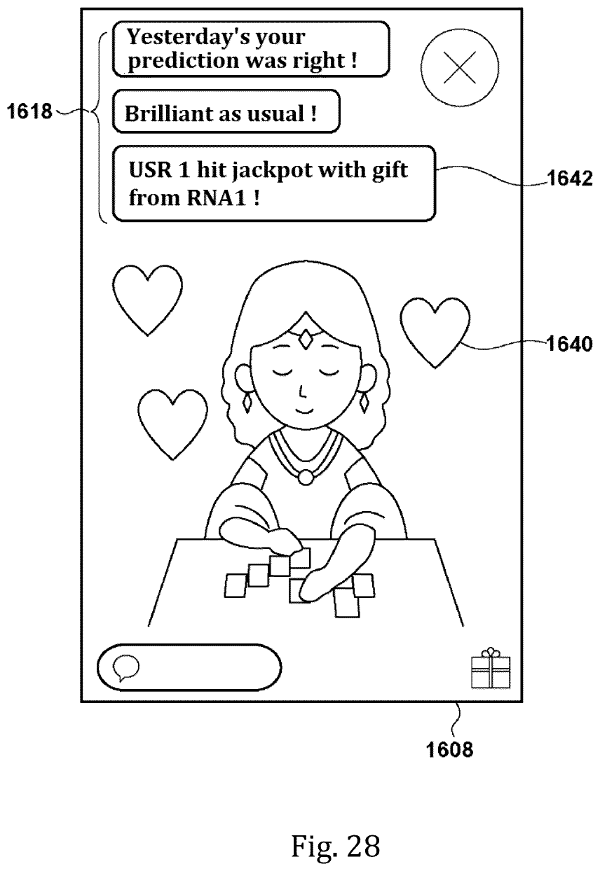

FIG. 28 is a representative screen image of the livestreaming room screen 1608 on which a jackpot effect 1640 is superimposed on the display of the viewer's user terminal 1030. In the example of FIG. 28, the jackpot effect 1640 includes three hearts. The comment display region 1618 includes a system message 1642 indicating that the viewer (user “USR1” in the example of FIG. 27) gave a random gift (“RAN1” in the example of FIG. 27) and hit the jackpot. By seeing the jackpot effect 1640 and/or the system message 1642, the viewer can tell that the viewer wins the jackpot for the random gift “RAN1” in the livestream that he/she is currently watching.

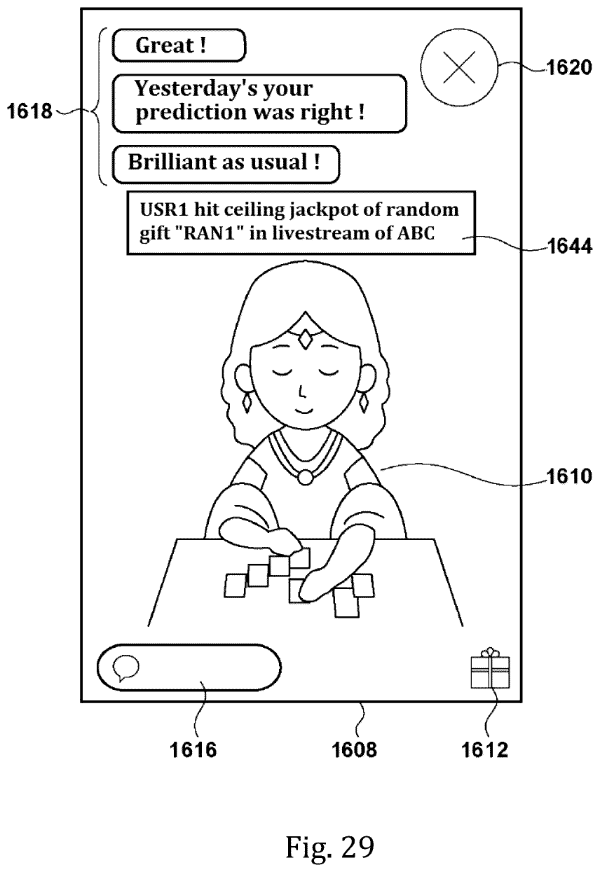

Upon reception of the ceiling jackpot notification from the server 1010 while the livestreaming room screen 1608 is shown on the display, the viewer-side UI control unit superimposes a ceiling jackpot notification display region 1644, which shows the contents of the ceiling jackpot notification, on the livestreaming room screen 1608. FIG. 29 is a representative screen image of the livestreaming room screen 1608 having the ceiling jackpot notification display region 1644 superimposed thereon, which appears on the display of the viewer's user terminal 1030. The ceiling jackpot notification display region 1630 may be a ticker field displaying the user ID of the viewer included in the ceiling jackpot notification, the user ID of the livestreamer included in the ceiling jackpot notification, the name of the random gift identified by the gift ID included in the ceiling jackpot notification, and text indicating that the random gift has hit the ceiling jackpot. The viewer-side UI control unit may display a system comment indicating the contents of the ceiling jackpot notification in the comment display region 1618 instead of or in addition to the ceiling jackpot notification display region 1644.

In the above embodiment, the DBs may be implemented by, for example, hard disks or semiconductor memory. It will be understood by those skilled in the art that each element or component can be realized by a CPU not shown, a module of an installed application program, a module of a system program, or a semiconductor memory that temporarily stores the contents of data read from a hard disk, and the like.

In the livestreaming system 1001 of the embodiment, the upper limit is set on the number of consecutive occurrences of non-jackpots for the random gift used in the livestreams, which reduces or eliminates users' complaint about the lack of jackpots. In addition, as the number of consecutive occurrences of non-jackpots approaches the upper limit, expectations for the jackpot increase, providing a sense of excitement and enjoyment for both the viewers and the livestreamers.

In the livestreaming system 1001 of the embodiment, the number of consecutive occurrences of non-jackpots for the random gifts is counted across the entire livestreaming platform provided by the server 1010. Therefore, compared to the case where the number of consecutive occurrences of non-jackpots is counted per viewer or per livestreamer/livestream, the probability of a jackpot being hit can be increased and/or the ceiling value can be set lower. When counting per viewer, there will be as many ceilings as the number of the viewers, so the probability of a jackpot must be set lower or the ceiling value must be set higher due to the expected value. The same applies when counting per livestreamer/livestream. Whereas when counting is performed independent of the viewers and independent of the livestreamers/livestreams, there is only one ceiling value per random gift, so the jackpot probability can be set higher or the ceiling value can be set lower. This allows the users to enjoy using the random gift more by realizing that the random gift is more likely to have a jackpot.

Further, by counting the number of consecutive occurrences of non-jackpots for the random gift across the entire livestreaming platform provided by the server 1010, the following advantageous effects can be obtained.
Even users who are not able to throw gifts often can get excitement and enjoyment by throwing a random gift aiming at the moment of the ceiling, regardless of whether or not they hit the jackpot.
The livestreamers can motivate the viewers to use the random gift. For example, if the ceiling is close, the livestreamers can say to the viewers, “The ceiling is close, so please throw the random gift.”
The period of time when there is a better chance of winning for users can be repeated, which motivates the users to throw or use the random gift.

In the livestreaming system 1001 of the embodiment, the users are notified of a difference between the number of consecutive occurrences of non-jackpots and the ceiling value. Therefore, the livestreamer can make a request by specifying the number of the random gifts, such as “throw X more random gifts,” which makes it easier for the viewers to fulfill their wishes compared to the situation where they do not know how many gifts they have to throw to win. In addition, the remaining number of the gifts to win is clear for the viewers, which makes it easier for the viewers to cooperate with each other.

Further, in the livestreaming system 1001, the preannouncement is provided to the users indicating that the number of consecutive occurrences of non-jackpots for the random gift is approaching the ceiling value. Thus, it is possible to create an atmosphere in which the users are tempted to use the random gift.

In addition, in the livestreaming system 1001 of the embodiment, the jackpot notification is provided to the user indicating that the random gift jackpot or ceiling jackpot has been hit. Thus, it becomes easier for users who are aiming for the ceiling to decide when to throw the random gift. Further, the users can experience the ease of hitting the jackpot for the random gift.

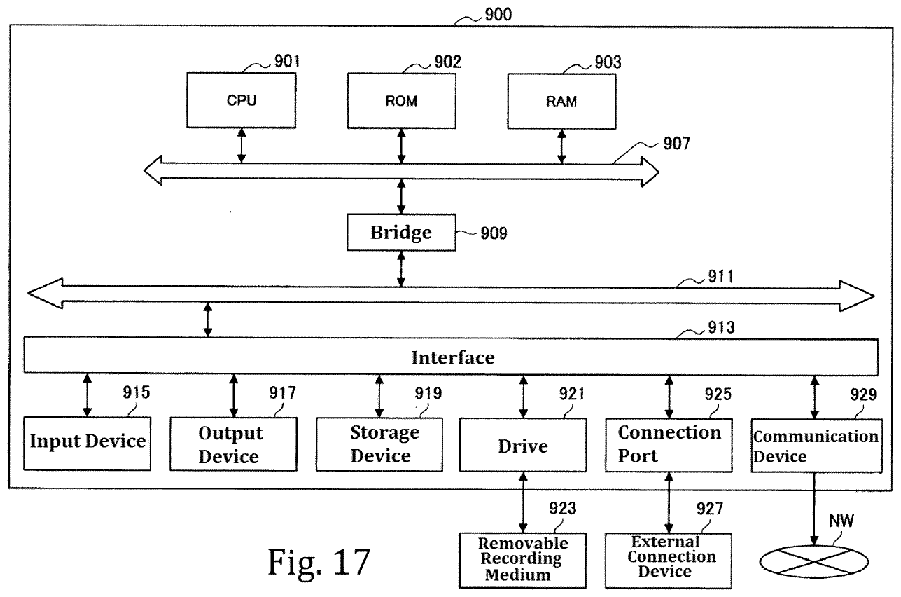

Referring to FIG. 17, the hardware configuration of an information processing device according to the first and second embodiments will be now described. FIG. 17 is a block diagram showing an example of a hardware configuration of an information processing device according to the first and second embodiments. The illustrated information processing device 900 may, for example, realize the server 10 and the user terminals 20 and 30 in the first embodiment and the server 1010 in the second embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). The CPU 901 is an example of a hardware structure that can realize the functions performed by the constituent elements described herein. The functions described herein may be performed by the circuitry programmed to realizing those functions. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the streaming unit 100, the image capturing control unit 102, the audio control unit 104, the video transmission unit 106, the livestreamer-side UI control unit 108, the livestreamer-side communication unit 110, the viewing unit 200, the viewer-side UI control unit 202, the viewer-side communication unit 204, the livestream information providing unit 302, the relay unit 304, the gift processing unit 308, the payment processing unit 310, the core time processing unit 330, the waiting period managing unit 332, the matching unit 334, the recommendation processing unit 336, the out-of-livestream processing unit 400, the out-of-livestream UI control unit 402, the out-of-livestream communication unit 404, the livestreaming information providing unit 1302, the relay unit 1304, the gift processing unit 1308, the payment processing unit 1310, the lottery unit 1330, the counting unit 1332, the difference notifying unit 1334, the jackpot notifying unit 1336, and the preannouncing unit 1338 may be embodied as circuitry programmed to realize such functions.

The CPU 901 functions as an arithmetic processing device and a control device, and controls all or some of the operations in the information processing device 900 according to various programs stored in the ROM 902, the RAM 903, the storage device 919, or the removable recording medium 923. For example, the CPU 901 controls the overall operation of each functional unit included in the server 10 and the user terminals 20 and 30 in the embodiment. The ROM 902 stores programs, calculation parameters, and the like used by the CPU 901. The RAM 903 serves as a primary storage that stores a program used in the execution of the CPU 901, parameters that appropriately change in the execution, and the like. The CPU 901, ROM 902, and RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the livestreaming systems 1 and 10001 in the first and second embodiments have been described. This embodiment is merely an example, and it will be understood by those skilled in the art that various modifications are possible by combining the respective components and processes, and that such modifications are also within the scope of the present disclosure.

In the first embodiment, as an example of providing the users with the information on the livestreams in the core time in preference to the information on the livestream outside of the core time, the case in which the users are made to spend more time and effort to watch the livestreams outside of the core time than is necessary to watch the livestreams in the core time has been described above. However, the example is not limited to this. For example, when calculating the matching score between the user and the currently available livestreams, the formula may be defined so that the matching scores for the livestreams in the core time become higher than the matching scores for the livestreams that are not in the core time. Alternatively, the livestreams outside of the core time may be removed from the recommendation list presented to the user. Alternatively, the system may be configured so that the livestreams that are in the core time are prioritized for inclusion when generating the recommendation list for the user.

In a modification example, upon reception of a request for information on livestreams from the user terminal of a user over the network NW, the livestream information providing unit 302 refers to the stream DB 314 and makes a list of currently available livestreams. This list includes livestreams that are in the core time and livestreams that are not in the core time. The livestream information providing unit 302 arrange the list so that the livestreams that are in the core time are provided preferentially over the livestreams that are outside of the core time. For example, the livestream information providing unit 302 removes livestreams that are outside of the core time from the list. Alternatively, the livestream information providing unit 302 sorts the list so that the livestreams that are in the core time are placed higher than the livestreams outside of the core time. The livestream information providing unit 302 transmits the arranged list to the requesting user terminal over the network NW. The requesting user terminal generates the livestream selection screen based on the received list and shows it on the display of the user terminal.

Once the user terminal receives the user's selection result of the live-stream on the live-stream selection screen, the user terminal generates a livestream request including the stream ID of the selected livestream, and transmits the request to the server 10 over the network NW. The livestream information providing unit 302 starts to provide, to the requesting user terminal, the livestream identified by the stream ID included in the received livestream request.

In the first embodiment, different degrees of priority are given between the livestreams in the core time and the livestreams outside of the core time. However, the embodiment is not limited to this, for example, different degrees of priority are given between the livestreamers in the core time and the livestreamers outside of the core time.

In the first embodiment, the case in which the list of the livestreams that are in the core time is independently provided as the core time livestream list 338 has been described. However, the embodiment is not limited to this. For example, the stream DB 314 and user DB 318 can be configured to further store information indicating whether each livestream and/or each livestreamer is in the core time or not and its remaining time.

The first embodiment describes the case in which the previous livestream is specified from the recommendation list, but it is not limited to this. For example, a user's viewing history can be maintained, and when the previous livestream is requested, the previous livestream can be specified from the viewing history. In this case, when the user wants to view a livestream that was previously viewed but is no longer in the core time and thus no longer in the updated recommendation list, the user can easily return to that livestream.

The first embodiment has described the case in which the recommendation list is managed by the server 10. However, it is not limited to this case, and the recommendation list for a user may be configured to be managed by the user terminal of the user. In this case, each time the recommendation list is updated, the user terminal obtains the contents of the latest core time livestream list 338 from the server.

The first embodiment describes the case where the recommendation list is established for each user, but it is not limited to this. For example, setting the order for the livestreams according to the matching scores may not be performed. In this case, when activation of the application is detected at a user terminal, the server starts relaying the livestream registered at the top of the core time livestream list 338 to the user terminal. When the livestream change request is received thereafter, the server determines the next livestream to be provided by referring to the core time livestream list 338. Alternatively, the server may transmit a copy of the core time livestream list 338 to the user terminal when the activation of the application is detected at the user terminal. The user terminal refers to the copy of the list to determine the livestream to be received. In this case, each time the core time livestream list 338 is updated, the server transmits the updated core time livestream list 338 to each user terminal.

The first embodiment has described the case in which the core time livestream list 338 is updated each time the core time button is pressed by the livestreamer. However, it is not limited to this case. Alternatively, new registration to the core time livestream list 338 may be performed in a batch process. For example, a provisional list that accumulates information on livestreams for which the core time button is pressed may be established, and the core time livestream list 338 may be configured to be periodically updated with the contents of the provisional list.

The first embodiment describes the case in which the live streaming room screen for showing the livestream in the core time is switched by swiping up and down, but it is not limited to this. For example, instead of the livestream room screen, a video or image uploaded to the system in advance by the livestreamer of the livestream in the core time may be displayed and switched. This video or image may include an object for viewing the corresponding livestream (currently in progress and in the core time). Alternatively, it may also display clips (short videos) or archives or previews generated from the livestream in the core time, and switch between these displays.

The first embodiment describes the case in which the recommendation list is updated at each recommendation update period, but it is not limited to this. For example, the recommendation list may be updated each time the core time livestream list 338 is updated, or each master update period. Alternatively, the recommendation list may also be updated when the user has watched all livestreams in the current recommendation list.

The first embodiment describes the case in which the display of the core time button starts or resumes when the waiting period elapses, but it is not limited to this case. For example, the timing when the core time can start may be determined based on factors such as specification of absolute time or conditions of livestreaming parameters. For example, the core time button may be displayed at 1:00 PM and 4:00 PM for one livestreamer, while the core time button may be displayed at 2:00 PM and 5:00 PM for another livestreamer. Alternatively, the display of the core time button may start when the score of the livestream outside of the core time exceeds a predetermined threshold or when the special gift is used. Alternatively, the display or non-display of the core time may be controlled based on the level of the livestreamer. Alternatively, a list of livestreamers who can display the core time button may be prepared, and the core time button may be displayed only in the livestreams of the livestreamers included in the list. By setting an upper limit to the number of the livestreamers who can be on this list, the number of livestreams in the core time can be controlled and the effectiveness of the core time can be enhanced. The list may be managed by the administrator of the livestreaming platform. For example, inclusion on the list can be set as a prize for event winners.

The first embodiment describes the case in which the livestreams in the core time is prioritized over the livestreams outside of the core time by difference in the effort required to view them, however, it is not limited to this. For example, different recommendation logic, recommendation methods, recommendation algorithms, etc. may be used between the livestreams in core time and the livestreams outside of the core time. Alternatively, the livestreams in the core time may be delivered to the users in a different manner than the livestreams outside of the core time. For example, the livestreaming application may have a tab in which only the livestreams (thumbnails) that are in the core time.

The conversion rate from the price points of a gift to a reward to be awarded in the first embodiment is merely an example, and the conversion rate may be appropriately set by the administrator of the livestreaming system, for example.

The technical idea according to the first embodiment may be applied to live commerce or virtual livestreaming using an avatar that moves in synchronization with the movement of the livestreamer instead of the image of the livestreamer.

The second embodiment has described the case in which the value of the difference between the number of times the random gift is used and the ceiling value is displayed in associated with the random gift object to notify the difference. However, it is not limited to this and information on the difference between the number of times the random gift is used and the ceiling value may be displayed. For example, the difference between the number of times the random gift has been used and the ceiling value may be expressed in terms of color, emphasis, movement or animation of the object or progress bar, rather than numerical values. Alternatively, the range of possible values for the difference between the number of times the random gift is used and the ceiling value may be divided into multiple ranges, and each range may be assigned a color or description (such as “far from the ceiling,” “halfway,” “near the ceiling,” “almost to the ceiling” etc.). In this case, for example, the description corresponding to the difference between the number of times the random gift is used and the ceiling value may be displayed with the random gift object. In an embodiment in which the difference between the number of times the random gift is used and the ceiling value is not indicated numerically, it is possible to indicate approximately the remaining number of times until the ceiling, without revealing how many the exact ceiling value is. It is also possible to configure the system so that the smaller the difference between the number of times the random gift is used and the ceiling value, the less the information indicating the difference changes or does not change at all. This makes it more difficult to predict the ceiling value.

Alternatively, when the user terminal receives the lottery results after the number of times the random gift is used exceeded the preannouncement value, the user terminal may cause the random gift object to be displayed on the display in a different manner than it was displayed before the number of times the random gift is used exceeded the preannouncement value. Furthermore, the user terminal may cause the random gift object to be displayed on the display in a manner that is independent of the number of uses after the number of uses exceeded the preannouncement value. For example, the random gift object may be displayed in a normal display manner until the number of uses reaches the preannouncement value, and after the number of uses exceeds the preannouncement value, the random gift object may be displayed in a special display manner different from the normal display manner. In this case, the special display style will remain the same until the random gift jackpot is reached. Alternatively, the color of the random gift object may continuously change from blue to red until the number of uses reaches the preannouncement value, and once the number of uses exceeds the preannouncement value, the color of the random gift object may be fixed at red.

Alternatively, the information indicating the difference between the number of times the random gift is used and the ceiling value may not be displayed until the difference reaches a threshold value smaller than the ceiling value, and the information indicating the difference may begin to be displayed when the difference reaches the threshold value. In this case, it is possible to avoid displaying the difference when the difference is large, and thus to prevent the display from discouraging users to throw the random gift when the difference is large.

The second embodiment has described the case in which the counting unit 1332 counts the number of times the random gift is used, independent of viewers who used the random gift and independent of the livestreamers of the livestreams in which the random gift was used. The counting unit 1332 counts the number of times each random gift is used for each livestreamer of the livestreams in which the random gift was used but independent of viewers who used the random gift. In this case, it is possible to aim for the ceiling of the random gift for each livestream, providing a livestreaming platform that is more enjoyable for livestreamers who are good at making their livestreams exciting. Alternatively, the counting unit 1332 may also count the number of times the random gift is used for each viewer who used the random gift but independent of the livestreamers of the livestreams in which the random gift was used. In this case, a sense of fairness can be created because each viewer is guaranteed to receive the ceiling jackpot. Alternatively, the counting unit 1332 may also count the number of times the random gift is used for each pair of a viewer and livestreamer.

In the second embodiment, the probability of occurrence of lottery result is predetermined, however the embodiment is not limited to this. For example, the probability of occurrence of each lottery result may be changed dynamically depending on the number of times the random gift is used. For example, the probability of occurrence of the jackpot may be set to increase as the number of times the gift is used approaches the ceiling value.

The second embodiment has described the random gift as a gift given from the viewer to the livestreamer, but it is not limited to this. The technical ideas of the embodiment can be applied to random gifts given from the livestreamer to the viewer, or from the viewer to another viewer.

The second embodiment has described the case in which the number of uses is reset when the jackpot is hit, but the embodiment is not limited to this. Other methods of counting the number of consecutive occurrences of the non-jackpot may be used. For example, instead of resetting the number of uses, the ceiling value may be updated. When the number of uses reaches the ceiling value, the ceiling value may be updated to increase by a predetermined number. For example, if the ceiling value is 100 and the number of uses reaches 100, the ceiling value may be updated to 200 while the number of uses remains at 100.

The conversion rate from the price points of a gift to a reward to be awarded in the second embodiment is merely an example, and the conversion rate may be appropriately set by the administrator of the livestreaming system, for example.

The technical idea according to the second embodiment may be applied to live commerce or virtual livestreaming using an avatar that moves in synchronization with the movement of the livestreamer instead of the image of the livestreamer. In the present embodiment, the video data related to the livestream that is generated at the user terminal of the livestreamer is relayed by the server and sent to the user terminal of the viewer. The present invention, however, is not limited to such. For example, the technical ideas of the present embodiment can also be applied to a case where a virtual livestreamer is set in place of an actual livestreamer. A virtual livestreamer is an AI virtual livestreamer having an appearance represented by an avatar, emits audio produced by a text-to-speech (TTS) engine, and says what is generated by a machine learning model receiving comments posted by viewers. In this case, the livestreamer's user terminal does not exist, and the processing on the livestreamer's side is performed by the server.

The second embodiment describes the case in which the lottery result ID and the reward given are the same but the effects are different (more splendid effects for the ceiling jackpot, FIGS. 27 and 28) between the jackpot for the normal lottery result and the jackpot for the number of the gift uses reaching the ceiling value, but it is not limited this. For example, the normal jackpot and the ceiling jackpot may be configured to be exactly the same, including their rewards and effects.

Alternatively, a lottery result ID identifying the ceiling jackpot may be provided separately from the lottery result ID identifying the normal jackpot in the lottery algorithm DB 1340 of FIG. 22. In this case, the normal jackpot and the ceiling jackpot are different in the random gift results. The reward for the ceiling jackpot may be different from the reward for the normal jackpot, for example, the former may be set higher than the latter. The effects of the ceiling jackpot may be different from those of the regular jackpot, e.g., the former may be set more luxurious than the latter. The ceiling jackpot effect may be as shown in FIG. 27, and the normal jackpot effect may be as shown in FIG. 28, in which case the effects shown in FIG. 27 and FIG. 28 represent the different lottery results from each other. In this modification example, by preparing a special gift for the ceiling jackpot, the system can provide a game element in which the player enjoys not winning until the count reaches the ceiling.

The second embodiment has described the case in which the lottery algorithm is configured to select the jackpot when the number of times the random gift is used reaches the ceiling value, but the embodiment is not limited to this. The lottery algorithm may be configured such that an outcome independent of the lottery or a predetermined outcome is selected when the number of times the random gift is used reaches the ceiling value. For example, the ceiling jackpot may be different from the regular jackpot as described above. Alternatively, the ceiling jackpot may be set to be the second normal hit (e.g., “RAN1B” or “RAN2B” in FIG. 22). In this way, the ceiling jackpot may be a given one of the regular non-jackpots. Alternatively, the attributes may be different between the ceiling jackpot and the regular jackpot. For example, the regular jackpot may be accompanied by the reward and effects, while the ceiling jackpot may be accompanied by prizes, bonuses to event ranking points, special banners or badges, and so on. Alternatively, after the number of uses reaches the ceiling value, a lottery with a higher chance of winning the jackpot (e.g., probability of winning the jackpot=50%, probability of winning the second hit=50%) may be performed.

Alternatively, it is also possible to have a ceiling period during which the ceiling value is set for the random gift and a non-ceiling period during which the ceiling value is not set. In this case, the use of the random gift during the ceiling period can be encouraged. Also, by making it difficult to know when the ceiling period will be, the game element can be enhanced and the livestream can be made more exciting.

In the second embodiment, the following four patterns of random gifts can be offered depending on the presence or absence of the ceiling value, high or low ceiling value, and the attributes of the ceiling jackpot.

(1) Random Gift with a Low Ceiling Value

It is possible to satisfy even light viewers by successively throwing the gifts.

(2) Random Gift with a High Ceiling Value

The livestreamers can easily request gifts from light users in their livestreams by telling them that the ceiling is close.

(3) Random Gift with No Ceiling Value

Since users will not give gifts when the ceiling is not close and there is a possibility of increased usage right before the ceiling and complaints of “I didn't hit the ceiling,” the system may provide the users with a choice with a random gift without the ceiling value.

### (4) Special Random Gift for Aiming the Ceiling Jackpot

The system can provide a playful way to get a special gift by continuing to lose in the random gift lottery.

The technical ideas relating to the second embodiment may be represented by the following items.

### <Item 1>

A server, including:
a receiving unit for receiving a gift use signal from a user terminal of a viewer who is participating a livestream in progress over a network, the gift use signal indicating that a gift is used for a livestreamer of the livestream;
a lottery unit selecting, upon reception of the gift use signal, one lottery result from among a plurality of lottery results in accordance with a predetermined lottery algorithm, each lottery result corresponding to a different amount of electronic representation of value;
a granting unit granting an amount of electronic representation of value corresponding to the selected lottery result to the livestreamer of the livestream; and
a counting unit counting a number of times the gift is used with reference to when a lottery result corresponding to a largest amount of the electronic representation of value is selected from among the plurality of lottery results;
wherein the predetermined lottery algorithm is configured such that a predetermined lottery result is selected when the number of times the gift is used reaches a threshold value.

### <Item 2>

The server of Item 1, wherein the predetermined lottery algorithm is configured such that the lottery result corresponding to the largest amount of the electronic representation of value is selected from among the plurality of lottery results when the number of times the gift is used reaches the threshold value.

### <Item 3>

The server of Item 1, wherein the counting unit counts the number of times the gift is used, independent of a viewer who used the gift.

### <Item 4>

The server of Item 1, wherein the counting unit counts the number of times the gift is used, independent of the livestreamer of the livestream in which the gift was used.

### <Item 5>

The server of Item 1, wherein the counting unit counts the number of times the gift is used, independent of a viewer who used the gift and independent of the livestreamer of the livestream in which the gift was used.

### <Item 6>

The server of Item 1, further includes a notifying unit notifies a terminal of a user of a livestreaming platform provided by the server of information indicating a difference between the number of times the gift is used and the threshold value.

### <Item 7>

The server of Item 2, further includes a notifying unit notifying to a terminal of a user of the livestreaming platform provided by the server of the corresponding content on one condition that the lottery result corresponding to the largest amount of the electronic representation of value is selected since the number of times the gift is used has reached the threshold value.

### <Item 8>

The server of Item 1, further includes a payment processing unit processing payment for a price of the gift by the viewer in response to reception of the gift use signal.

### <Item 9>

The server of Item 1, a notifying unit notifying to a terminal of a user of the livestreaming platform provided by the server of notification about the gift on one condition that the number of times the gift is used has reached another threshold value that is smaller than the threshold value.

### <Item 10>

The server of Item 9, wherein the notifying unit send the notification only to terminals of users that satisfy a predetermined condition.

### <Item 11>

The server of Item 1, wherein the counting unit counts the number of times the gift is used across the livestreaming platform provided by the server,
wherein the server further includes a notifying unit notifies the entire livestreaming platform provided by the server of the information indicating the difference between the number of times the gift is used and the threshold value.

### <Item 12>

A method performed by a server, including:
receiving a gift use signal from a user terminal of a viewer who is participating a livestream in progress over a network, the gift use signal indicating that a gift is used for a livestreamer of the livestream;
selecting, upon reception of the gift use signal, one lottery result from among a plurality of lottery results in accordance with a predetermined lottery algorithm, each lottery result corresponding to a different amount of electronic representation of value;
granting an amount of electronic representation of value corresponding to the selected lottery result to the livestreamer of the livestream; and
counting the number of times the gift is used with reference to when a lottery result corresponding to a largest amount of the electronic representation of value is selected from among the plurality of lottery results;
wherein the predetermined lottery algorithm is configured such that a predetermined lottery result is selected when the number of times the gift is used reaches a threshold value.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server may be realized by a device(s) other than the server, for example, the user terminals. At least some of the functions realized by the user terminals may be realized by a device(s) other than the user terminals, for example, the server. For example, the superimposition of a predetermined frame image on an image of the video data performed by the viewer's user terminal may be performed by the server or may be performed by the livestreamer's user terminal.

What is claimed is:

1. A server comprising a circuitry, wherein the circuitry is configured to:
start, in a starting unit, a preferential delivery period of a livestream in response to reception of a preferential delivery period start request from a terminal of a livestreamer performing the livestream during the livestream;
manage, in a managing unit, when a next preferential delivery period can be started for the livestream; and
perform processing, in a processing unit, to provide information on livestreams that are in the preferential delivery period to a user in priority over information on livestreams outside of the preferential delivery period.

2. The server of claim 1, wherein, in the managing unit, start of the next preferential delivery period is enabled when a waiting period that is longer than the preferential delivery period has elapsed since the preferential delivery period started.

3. The server of claim 2, wherein, in the managing unit, the waiting period is shortened when there is a payment by the livestreamer performing the livestream or by a viewer watching the livestream.

4. The server of claim 2, wherein, in the managing unit, a length of the preferential delivery period or a length of the waiting period or both is adjusted depending on a change in a parameter during the livestream.

5. The server of claim 1, wherein, in the processing unit, processing is performed to provide the user with the information only on the livestreams that are in the preferential delivery period.

6. The server of claim 1, wherein, in the processing unit, a livestream to be provided to the user is selected from a list of the livestreams that are in the preferential delivery period.

7. The server of claim 6, wherein the circuitry is further configured to, in an updating unit, register a livestream whose preferential delivery period has newly started in the list and remove a livestream whose previously started preferential delivery period has expired from the list.

8. The server of claim 6, wherein the circuitry is further configured to, in a relay unit, relay video data of a first livestream registered in the list from a terminal of a livestreamer of the first livestream to a terminal of the user,
wherein, in the processing unit, when a livestream change request is received from the terminal of the user over a network, a second livestream different from the first livestream is selected from the list, and
wherein, in the relay unit, relay of video data of the second livestream from a terminal of a livestreamer of the selected second livestreamer to the terminal of the user is started.

9. A method, comprising:
starting a preferential delivery period of a livestream in response to reception of a preferential delivery period start request from a terminal of a livestreamer of the livestream during the livestream;
managing when a next preferential delivery period can be started for the livestream; and
performing processing to provide information on livestreams that are in the preferential delivery period to a user in priority over information on livestreams outside of the preferential delivery period.

10. The method of claim 9, wherein, in the managing, start of the next preferential delivery period is enabled when a waiting period that is longer than the preferential delivery period has elapsed since the preferential delivery period started.

11. The method of claim 10, wherein, in the managing, the waiting period is shortened when there is a payment by the livestreamer performing the livestream or by a viewer watching the livestream.

12. The method of claim 10, wherein, in the managing, a length of the preferential delivery period or a length of the waiting period or both is adjusted depending on a change in a parameter during the livestream.

13. The method of claim 9, wherein, in the processing, processing is performed to provide the user with the information only on the livestreams that are in the preferential delivery period.

14. The method of claim 9, wherein, in the processing, a livestream to be provided to the user is selected from a list of the livestreams that are in the preferential delivery period.

15. The method of claim 14, further comprising registering a livestream whose preferential delivery period has newly started in the list and removing a livestream whose previously started preferential delivery period has expired from the list.

16. The method of claim 14, further comprising relaying video data of a first livestream registered in the list from a terminal of a livestreamer of the first livestream to a terminal of the user,
wherein, in the processing, when a livestream change request is received from the terminal of the user over a network, a second livestream different from the first livestream is selected from the list, and
wherein, in the relaying, relay of video data of the second livestream from a terminal of a livestreamer of the selected second livestreamer to the terminal of the user is started.

17. A terminal of a livestreamer of a livestream, comprising:
one or more processors; and
memory storing one or more computer programs configured to be executed by the one or more processors,
the one or more computer programs including instructions for:
receiving an instruction to start a preferential delivery period from the livestreamer during the livestream;
transmitting a preferential delivery period start request to the server of claim 1 over a network in response to the reception of the instruction to start the preferential delivery period; and
starting to receive an instruction to start the next preferential delivery period once time when the next preferential delivery period can be started comes.
